(19) United States
(12) Patent Application Publication
(10) Pub. No.: US 2025/0282633 A1
(43) Pub. Date: Sep. 11, 2025

(54) SEQUENTIAL HYDROMETALURGICAL RECOVERY OF METAL VALUES WITH SEQUESTERED CARBON

(71) Applicant: NEGATIVE EMISSIONS MATERIALS, INC., New Castle, DE (US)

(72) Inventors: David DREISINGER, Delta (CA); Jeremy William LEY, Paris (FR); Ken BAXTER, Bull Creek (AU)

(21) Appl. No.: 18/858,603

(22) PCT Filed: Apr. 25, 2023
(86) PCT No.: PCT/IB2023/054247

§ 371 Date: Oct. 21, 2024

Related U.S. Application Data
(60) Provisional application No. 63/334,386, filed on Apr. 25, 2022.
(60) Provisional application No. 63/341,073, filed on May 12, 2022.

(51) Int. Cl. C01F 5/02; B01D 53/14; B01D 53/62; B01D 53/78; B01D 53/96; C01D 7/07; C01F 5/22; C01F 5/24; C01F 7/34; C01F 11/02; C01G 37/02; C01G 45/024; C01G 49/04; C01G 49/06; C01G 51/05; C01G 53/05; C01G 53/06; C22B 1/24; C22B 3/00; C22B 3/10; C22B 3/42; C22B 3/44; C22B 21/00; C22B 26/22; C22B 47/00; C25B 1/16; C25B 1/22; C25B 1/34; C25B 15/08

(52) U.S. Cl. CPC C01F 5/02; B01D 53/1418; B01D 53/1475; B01D 53/1493; B01D 53/62; B01D 53/78; B01D 53/965; C01D 7/07; C01F 5/22; C01F 5/24; C01F 7/34; C01F 11/02; C01G 37/02; C01G 45/024; C01G 49/04; C01G 49/06; C01G 51/05; C01G 53/05; C01G 53/06; C22B 1/24; C22B 3/10; C22B 3/42; C22B 3/44; C22B 21/0015; C22B 23/0423; C22B 23/0461; C22B 26/22; C22B 47/00; C25B 1/16; C25B 1/22; C25B 1/34; C25B 15/081; B01D 2251/304; B01D 2251/604; B01D 2257/504; B01D 2258/06

(57) ABSTRACT

Processes are provided in which successive steps of hydrometallurgical value extraction may be carried out using the products of carbon capture and an electrolytic reagent-generating process. The electrolytic process provides an acid leachant and an alkali hydroxide, with the alkali hydroxide then available for use either directly as a precipitant in the hydrometallurgical steps, or available for conversion by carbon capture to an alkali metal carbonate that can in turn be used as the precipitant in the selective hydrometallurgical steps.

### FIELD

The invention is in the field of inorganic chemistry, involving processes for magnesium oxide production and recycling with steps of hydrometallurgical value extraction from mineral feedstocks.

### BACKGROUND

Technologies for efficient sequestration of gaseous carbon dioxide are potentially an important tool for addressing anthropogenic climate change. Various approaches have been suggested for sequestering carbon as mineral carbonates, including techniques that accelerate weathering reactions of minerals in ultramafic and mafic source rocks. These enhanced weathering (on land) or ocean alkalinity enhancement (at sea) approaches consume CO₂ but are necessarily accompanied by a release of mineral dissolution products such as alkaline species and metal compounds, for example Si, Ca, Mg, Fe, Ni, and Co species. The ecological effect of these processes are uncertain (see Bach et al., 2019). There is a need for processes that integrate carbon capture with the recovery of metal values from mineral feedstocks.

### SUMMARY

Processes are provided in which successive steps of hydrometallurgical value extraction are carried out on a mineral feedstock, such as an olivine, mafic, saprolite or ultramafic feedstock. In select embodiments, the products of carbon capture reactions and an electrolytic reagent-generating process are utilized as inputs to hydrometallurgical value recovery steps. The electrolytic process provides the acid leachant (HCl or H₂SO₄) and an alkali hydroxide (NaOH or KOH), with the alkali hydroxide then available for use either directly as a precipitant in the hydrometallurgical steps, or available for conversion to an alkali metal carbonate or bicarbonate that can in turn be used as the precipitant in the hydrometallurgical steps. In an alternative embodiment, the alkali hydroxide from the chloralkali process may be used to precipitate a calcium hydroxide product, with the calcium hydroxide product then available for use directly in carbon dioxide gas scrubbing, or for use to accept a carbonate that is provided by a CO₂ scrubbing process.

Processes are accordingly provided for the coproduction from mineral feedstocks such as basaltic rocks of less carbon intensive, or carbon negative, nickel, iron, calcium and magnesium hydroxides or carbonates. Basaltic sand materials that include amorphous silicates may also be produced. These processes may involve (1) magnetic separation, (2) hydrochloric or sulfuric acid leaching, (3) selective precipitation of metal hydroxides or carbonates in successive steps, which may involve pH modulation (in select embodiments, nickel may for example be separated using a resin in leach step) (4) electrolysis of a resulting barren solution, for example a chloralkali process for treating NaCl_{(aq)}, or an electrolytic salt splitting anion exchange process for treating Na₂SO_{4(aq)}, and (5) acid and alkali reagent recycling, for example in the case of a chloralkali process, hydrochloric acid production from the hydrogen and chlorine gas products of the electrolysis.

Process of the invention accordingly provide for the use of less carbon intensive nickel, iron, calcium and magnesium hydroxides or carbonates, as well as olivine and basaltic sand material, including amorphous silicates, in marketable products. These may for example include feedstocks for battery, steel, cement, tyre, glass, aggregate, or concrete industries. Products of the present processes, such as the solid siliceous residue or iron precipitate products, may for example be subject to washing and/or alkalization. The adjustment of pH by way of alkalization (alkali addition) may improve the suitability of the final product, for example to produce a siliceous residue suitable for use as a supplementary cementitious material (SCM) in cements with improved cementitious properties.

The present processes provide avenues for the coproduction of less carbon intensive nickel and iron hydroxides, and this in turn may provide avenues to decarbonate sectors associated with the transition to a low carbon economy—such as electric vehicles and batteries. The invention also facilitates low carbon steelmaking, by compensating carbon heavy pyrometallurgy with a carbon negative magnetic, hydrometallurgical and electrochemical process.

The present processes provide for the coproduction of less carbon intensive amorphous silicates, marketable as a supplementary cementitious material (SCM) for cements, or in the tyre manufacturing industry. Basaltic sand materials may be produced by the present processes, with an inert surface, for example for use as aggregate in concrete mixes. The invention accordingly facilitates the construction of less carbon intensive concrete buildings.

Processes are accordingly provided for processing a comminuted mineral feedstock, comprising:
optionally magnetically separating material from the comminuted mineral feedstock;
a) leaching metal values from the comminuted mineral feedstock with an acid leachant, to produce a solid siliceous residue and a loaded leach solution;
optionally subjecting the loaded leach solution to a resin in leach process so as to selectively remove nickel and cobalt values from the loaded leach solution, to obtain a purified nickel and cobalt combined product,
optionally, washing and/or alkalization of the solid siliceous residue, for example to form a supplementary cementitious material (SCM) for use in cements;
b) precipitating iron and/or aluminum from the loaded leach solution with addition of:
   an first alkaline-earth metal oxide precipitant,
   a first alkali metal carbonate or bicarbonate precipitant, to produce a carbon dioxide off gas, or,
   a first alkali hydroxide precipitant,
to produce an Fe/Al depleted solution and an iron and/or aluminum hydroxide or oxide (e.g. hematite) precipitate product;
optionally, washing and/or alkalization of the iron and/or aluminum hydroxide precipitate product;
optionally, adding a hematite seed material to the step of precipitating iron and/or aluminum, wherein the iron and/or aluminum hydroxide precipitate product may comprise the hematite seed material, which is then recirculated to the precipitation step;
c) precipitating nickel and/or cobalt from the Fe/Al depleted solution or from a Ni/Co ion exchange eluant obtained from the Fe/Al depleted solution by selective extraction of Ni and/or cobalt on an ion exchange medium, wherein the precipitating is with addition of:
   a second alkaline-earth metal oxide precipitant,
   a second alkali metal carbonate or alkali metal bicarbonate precipitant, or,
   a second alkali hydroxide precipitant,
to produce a Ni/Co depleted solution and a nickel and/or cobalt carbonate or hydroxide precipitate product;
d) before or after step (c), precipitating iron and/or aluminum and/or manganese from the Ni/Co depleted solution with addition of an oxidant and with addition of:
   a third alkali metal carbonate or bicarbonate precipitant, or,
   a third alkali hydroxide precipitant,
to produce an Fe/Al/Mn depleted solution and an iron and/or aluminum and/or manganese hydroxide precipitate product;
optionally recycling a brine comprising the Fe/Al/Mn depleted solution to a comminuting step to provide the comminuted mineral feedstock;
e) optionally precipitating magnesium from the Fe/Al/Mn depleted solution with addition of:
   a fourth alkali hydroxide precipitant, or
   a fourth alkali metal carbonate or bicarbonate precipitant,
to produce a Mg-depleted solution and a magnesium hydroxide or carbonate precipitate product;
e′) in place of precipitating magnesium from the Fe/Al/Mn depleted solution, precipitating manganese from the Fe/Al/Mn depleted solution, with the addition of a third alkaline-earth metal oxide precipitant, to produce a solid manganese residue and a magnesium chloride solution;
f) optionally subjecting the Mg-depleted solution to an electrolysis process to produce the acid leachant and:
   one or more of the alkali hydroxide precipitants, or
   an alkali hydroxide product, available for conversion into one or more of the alkali metal carbonate or bicarbonate precipitants;
f′) in place of subjecting the Mg-depleted solution to the electrolysis process, applying heat to the magnesium chloride solution to produce a magnesium chloride solid product, then applying heat to the magnesium chloride solid product to pyrolytically produce the acid leachant and a magnesium oxide product; and,
g) optionally sequestering carbon dioxide from a CO₂ containing gas, for example by reaction with the alkali hydroxide product, and/or in one or more of: the nickel and/or cobalt carbonate precipitate product; or, the magnesium hydroxide precipitate product.

In select embodiments, processes are provided for processing a comminuted mineral feedstock, comprising:
a) leaching metal values from the comminuted mineral feedstock with an HCl acid leachant, to produce a solid siliceous residue and a loaded leach solution;
a′) washing and/or alkalization of the solid siliceous residue, for example to form a supplementary cementitious material (SCM) for use in cements;
b) precipitating iron and aluminum from the loaded leach solution with addition of:
   a first alkali hydroxide precipitant, NaOH,
to produce an Fe/Al depleted solution and an iron and aluminum hydroxide/oxide precipitate product;
b′) washing the iron and aluminum hydroxide/oxide precipitate product;
c) precipitating nickel and cobalt from the Fe/Al depleted solution, wherein the precipitating is with addition of:
   a second alkali hydroxide precipitant, NaOH,
to produce a Ni/Co depleted solution and a nickel and cobalt mixed hydroxide precipitate product;
d) precipitating manganese from the Ni/Co depleted solution with addition of an NaOCl oxidant and with addition of:
   a third alkali hydroxide NaOH precipitant,
to produce an Mn depleted solution and a manganese hydroxide precipitate product;
d′) recycling a brine comprising the Mn depleted solution to a comminuting step to provide the comminuted mineral feedstock;
e) precipitating magnesium from the Mn depleted solution with addition of:
   a fourth alkali hydroxide NaOH precipitant, or
to produce a Mg-depleted solution and a magnesium hydroxide or precipitate product;
f) optionally subjecting the Mg-depleted solution to an electrolysis process to produce the acid leachant and:
   the NaOH alkali hydroxide precipitants.

Processes may further include scrubbing carbon dioxide from a CO₂ containing gas, including ambient air, by treating the CO₂ containing gas with a scrubbing solution comprising the alkali hydroxide precipitant, to produce one or more of the alkali metal carbonate or bicarbonate precipitants.

Processes are according provided for processing a comminuted mineral feedstock, comprising:
a) leaching metal values from the comminuted mineral feedstock with an acid leachant, to produce a solid siliceous residue and a loaded leach solution;
b) precipitating iron and/or aluminum from the loaded leach solution with addition of:
   an first alkaline-earth metal oxide precipitant,
   a first alkali metal carbonate precipitant, to produce a carbon dioxide off gas (which may for example be directed to: capture and storage of the CO₂ from the neutralization process, deep well injection, or the manufacture of biofuels or other chemicals), or,
a first alkali hydroxide precipitant, to produce an Fe/Al depleted solution and an iron and/or aluminum hydroxide or oxide precipitate (such as hematite) product;
c) precipitating nickel and/or cobalt from the Fe/Al depleted solution or from a Ni/Co ion exchange eluant obtained from the Fe/Al depleted solution by selective extraction of nickel and/or cobalt on an ion exchange medium, wherein the precipitating is with addition of:
   a second alkaline-earth metal oxide precipitant,
   a second alkali metal carbonate or bicarbonate precipitant, or,
   a second alkali hydroxide precipitant,
to produce a Ni/Co depleted solution and a nickel and/or cobalt carbonate or hydroxide precipitate product, such as a mixed Ni/Co hydroxide product;
d) before or after step (c), precipitating iron and/or aluminum and/or manganese from the Ni/Co depleted solution with addition of an oxidant (such as chlorine gas (Cl_{2(g)}) or sodium hypochlorite (NaOCl)) and with addition of:
   a third alkali metal carbonate or bicarbonate precipitant, or,
   a third alkali hydroxide precipitant,
to produce an Fe/Al/Mn depleted solution and an iron and/or aluminum and/or manganese hydroxide precipitate product;
e) optionally precipitating magnesium from the Fe/Al/Mn depleted solution with addition of:
   a fourth alkali hydroxide precipitant, or
   a fourth alkali metal carbonate or bicarbonate precipitant,
to produce a Mg-depleted solution and a magnesium hydroxide or carbonate precipitate product;
e′) in place of precipitating magnesium from the Fe/Al/Mn depleted solution, precipitating manganese from the Fe/Al/Mn depleted solution, with the addition of a third alkaline-earth metal oxide precipitant, to produce a solid manganese residue and a magnesium chloride solution;
f) optionally subjecting the Mg-depleted solution to an electrolysis process to produce the acid leachant and:
   one or more of the alkali hydroxide precipitants, or
   an alkali hydroxide product.

Processes may further involve reacting the alkali hydroxide product of the electrolysis process directly or indirectly with a carbon source to produce one or more of the alkali metal carbonate or bicarbonate precipitants, or the alkaline-earth metal carbonate precipitant. The step of reacting the alkali hydroxide product with a carbon source may involve scrubbing carbon dioxide from a CO₂ containing gas by treating the CO₂ containing gas with a scrubbing solution comprising the alkali hydroxide product, to produce one or more of the alkali metal carbonate or bicarbonate precipitants, or the alkaline-earth metal carbonate precipitant.

In select embodiments, calcium may be precipitated from the Mg-depleted solution with a fifth alkali hydroxide precipitant, to produce a calcium hydroxide product, and an alkaline-earth metal, or the alkali metal carbonate or bicarbonate precipitants may then be generated, directly or indirectly by treating the calcium hydroxide product with a carbon source, such as a CO₂ containing gas or a metal carbonate (the CO₂ containing gas may for example be air or a flue gas). When the alkali hydroxide product comprises NaOH, scrubbing carbon dioxide from the CO₂ containing gas may accordingly involve precipitating Na₂CO₃ hydrates from the scrubbing solution in a crystallisation process to produce a solid Na₂CO₃ crystallizer product, and one or more of the alkali metal carbonate or bicarbonate precipitants comprises the solid Na₂CO₃ crystallizer product.

In alternative embodiments, the alkali metal carbonate or bicarbonate precipitant may be one or more of NaHCO₃, Na₂CO₃ or K₂CO₃, or a mixture thereof. The alkali hydroxide precipitant may be one or both of NaOH or KOH, or a mixture thereof. The acid leachant may for example be a mineral acid, such as HCl or H₂SO₄, or a mixture thereof.

In alternative embodiments, a magnesium oxide (MgO) product may be produced, for use by recycling as an alkaline-earth metal precipitant, and/or for use in carbon dioxide capture reactions. The MgO product may for example be produced in a process involving the production of a magnesium chloride (MgCl₂) salt, with the MgCl₂ salt then pyrohydrolyzed to produce MgO.

The electrolysis process may involve a chloralkali process, producing the alkali hydroxide precipitant and/or the alkali hydroxide product, a Cl_{2(g)} product and a H_{2(g)} product. The Cl_{2(g)} product and the H_{2(g)} product may then be reacted to produce HCl as the acid leachant.

When the Mg-depleted solution includes Na₂SO₄, the electrolysis process may involve a salt splitting process that includes electrolytic generation of: the alkali hydroxide product and/or the alkali hydroxide precipitant; and, H₂SO₄ as the acid leachant.

Precipitating magnesium from the Fe/Al/Mn depleted solution with the alkali hydroxide precipitant, may involve addition of a CO_{2(g)} precipitant to produce the Mg-depleted solution and the magnesium carbonate precipitate product. The CO_{2(g)} precipitant may for example include, or be made entirely from, the carbon dioxide off gas from the step of precipitating iron and/or aluminum from the loaded leach solution.

In select embodiments, an initial step of magnetically separating material from the comminuted mineral feedstock may be implements, for example so as to enrich the feedstock in select materials.

In select embodiments, the loaded leach solution may be subjected to a resin in leach process so as to selectively remove nickel values from the loaded leach solution, to obtain a purified nickel product.

The products of the process may be further treated for example by washing and/or alkalization of the solid siliceous residue, washing and/or alkalization of the iron and/or aluminum hydroxide or oxide precipitate product.

A hematite seed material may be added to the step of precipitating iron and/or aluminum so as to seed the precipitation of a hematite product. When the iron and/or aluminum hydroxide or oxide precipitate product comprises a hematite seed material, the hematite seed material may be recirculated to the step of precipitating iron and/or aluminum so as to seed the precipitation of a hematite product.

A brine that includes some or all of the Fe/Al/Mn depleted solution may be recirculated to the comminuting step, to provide the comminuted mineral feedstock.

The mineral feedstock may for example be, or include, one or more of a nickel saprolite ore or tailing, an olivine ore or tailing, an asbestos ore or tailing, a mafic mineral, a saprolite material, an ultramafic rock, olivine, wollastonite or combinations thereof.

In select embodiments, NaOH is used as a strong base, with a pH of ˜14 for a 40 g/L NaOH solution, for CO₂ adsorption, converting NaOH to Na₂CO₃ which is lower strength base, with a pH of around 12-12.5. The Na₂CO₃ solution may the be used, as an alternative to an NaOH solution, in various aspects of the present process, particularly in steps where the Na₂CO₃ solution is used as the precipitant (i.e. the alkali metal carbonate precipitant). In pilot processes, the use of the Na₂CO₃ precipitant has demonstrated a number of surprising features. For example, when using the Na₂CO₃ solution to precipitate Fe, the Na₂CO₃ as a milder base provides for a more effective and controlled precipitation process for Fe. This is also the case with the use of the Na₂CO₃ solution to precipitate Al/Cr. When the Na₂CO₃ solution is used to precipitate Ni/Co, a Ni/Co mixed carbonate precipitate is produced, which provides a mixed product that is more crystalline, easier to separate from solution, lower in chloride content, and lower in moisture when filtered.

### BRIEF DESCRIPTION OF THE DRAWINGS

FIG. 1 is a schematic illustration of an integrated process for hydrometallurgical value extraction from a mineral feedstock, with reactants for the hydrometallurgical process provided by capture of carbon dioxide and a chloralkali electrochemical process.

FIG. 2 is a schematic illustration of an integrated process for hydrometallurgical value extraction from a mineral feedstock, with reactants for the hydrometallurgical process provided by capture of carbon dioxide and a chloralkali electrochemical process.

FIG. 3 is a schematic illustration of an integrated process for hydrometallurgical value extraction from a mineral feedstock, with reactants for the hydrometallurgical process provided by capture of carbon dioxide and a chloralkali electrochemical process.

FIG. 4 is a schematic illustration of an integrated process for hydrometallurgical value extraction from a mineral feedstock, with reactants for the hydrometallurgical process provided by capture of carbon dioxide and a chloralkali electrochemical process.

FIG. 5 is a schematic illustration of an integrated process for hydrometallurgical value extraction from a mineral feedstock, with reactants for the hydrometallurgical process provided by capture of carbon dioxide and a chloralkali electrochemical process, showing the use of Na₂CO₃ to precipitate Mg.

FIG. 6 is a schematic illustration of an integrated process for hydrometallurgical value extraction from a mineral feedstock, with reactants for the hydrometallurgical process provided by capture of carbon dioxide and a chloralkali electrochemical process, showing the use of NaOH in combination with CO_{2(g)} to precipitate Mg.

FIG. 7 is a schematic illustration of an integrated process for hydrometallurgical value extraction from a mineral feedstock, with reactants for the hydrometallurgical process provided by an electrolytic salt splitting anion exchange process.

FIG. 8 is a schematic illustration of an integrated process for hydrometallurgical value extraction from a mineral feedstock, with reactants for the hydrometallurgical process provided by capture of carbon dioxide (DAC) and an electrolytic salt splitting anion exchange process.

FIG. 9 is a schematic illustration of an integrated process for hydrometallurgical value extraction from a mineral feedstock, with reactants for the hydrometallurgical process provided by capture of carbon dioxide (DAC) and an electrolytic salt splitting anion exchange process.

FIG. 10 is a schematic illustration of an integrated process for hydrometallurgical value extraction from a mineral feedstock, with reactants for the hydrometallurgical process provided by capture of carbon dioxide (DAC) and an electrolytic salt splitting anion exchange process.

FIG. 11 is a schematic illustration of an integrated process for hydrometallurgical value extraction from a mineral feedstock, which includes an initial step of magnetic beneficiation to adjust the metal content of the treated material.

FIG. 12 is a schematic illustration of an integrated process for hydrometallurgical value extraction from a mineral feedstock, in which a MgCl₂ salt is produced, and pyrohydrolyzed to produce MgO as a base for recycle, for use as an alkaline-earth metal precipitant, as well optionally for use as a product, for use for example in carbon sequestration, and for use to produce HCl for recycle to the leaching step.

FIG. 13 is a schematic illustration of a Direct Air Capture (DAC) circuit configuration.

FIG. 14 is a schematic illustration of an integrated and exemplified process for hydrometallurgical value extraction from a mineral feedstock, with reactants for the hydrometallurgical process provided by a chloralkali electrochemical process.

FIG. 15 includes two line graphs illustrating exemplified batch leaching results for saprolite. Typical conditions: Temperature 100° C., 4 h, 87 g/L Mg (added as MgCl₂).

FIG. 16 includes two line graphs illustrating exemplified batch leaching results for olivine. Typical conditions: Temperature 100° C., 4 h, 87 g/L Mg (added as MgCl₂).

FIG. 17 includes two line graphs illustrating exemplified batch leaching results for asbestos tailings. Typical conditions: Temperature 100° C., 4 h, 87 g/L Mg (added as MgCl₂).

FIG. 18 is a schematic illustration of an exemplified pilot plant process for hydrometallurgical value extraction from a mineral feedstock, with reactants for the hydrometallurgical process provided by a chloralkali electrochemical process.

FIG. 19 is a line graph illustrating saprolite leaching results over 18 time periods of pilot plant operation.

FIG. 20 is a line graph illustrating primary neutralization calculated precipitation in an exemplified pilot plant process.

FIG. 21 is a line graph illustrating primary neutralization solids assay in an exemplified pilot plant process.

FIG. 22 is a line graph illustrating secondary neutralization precipitation efficiency in an exemplified pilot plant process.

FIG. 23 is a line graph illustrating secondary neutralization solids assay in an exemplified pilot plant process.

FIG. 24 is a line graph illustrating primary mixed hydroxide precipitation efficiency in an exemplified pilot plant process.

FIG. 25 is a line graph illustrating primary mixed hydroxide precipitation solid assay in an exemplified pilot plant process.

FIG. 26 is a line graph illustrating secondary mixed hydroxide precipitation efficiency in an exemplified pilot plant process.

FIG. 27 is a line graph illustrating secondary mixed hydroxide precipitation solids assay in an exemplified pilot plant process.

FIG. 28 is a line graph illustrating manganese precipitation efficiency in an exemplified pilot plant process.

FIG. 29 is a line graph illustrating manganese precipitation solids assay in an exemplified pilot plant process.

### DETAILED DESCRIPTION

Processes are provided in which successive steps of hydrometallurgical value extraction are carried out using the products of carbon capture and an electrolytic reactant regeneration process, such as a chloralkali process or an electrolytic salt splitting anion exchange process. The electrolytic reactant regeneration process provides an acid leachant and an alkali hydroxide, with the alkali hydroxide (e.g. NaOH) then available for use either directly as a precipitant in the hydrometallurgical steps, or available for conversion to an alkali metal carbonate (e.g. Na₂CO₃) or bicarbonate (e.g. NaHCO₃) that can in turn be used as the precipitant in the hydrometallurgical steps.

In an alternative embodiment, the alkali hydroxide from the chloralkali process may be used to precipitate a calcium hydroxide product, with the calcium hydroxide product then available for use directly in carbon dioxide gas scrubbing, or for use to accept a carbonate that is provided by a CO₂ scrubbing process.

In some embodiments, a crystalliser step may be introduced to precipitate Na₂CO₃ or Na₂CO₃ hydrates from a CO₂ enriched solution that is being treated with the alkali hydroxide (NaOH) product of the chloralkali process. In such processes, a crystalliser may be used to reduce water content in the hydrates by modulating temperature, pressure and NaOH concentration. The solid Na₂CO₃ product may then be used as a carbonate precipitant.

By using a carbonate precipitant to precipitate iron and aluminum from the leach solution, at a suitably low pH, the carbonate will decompose to release a concentrated stream of CO₂, and the concentrated CO₂ stream may in turn be sequestered or fixed.

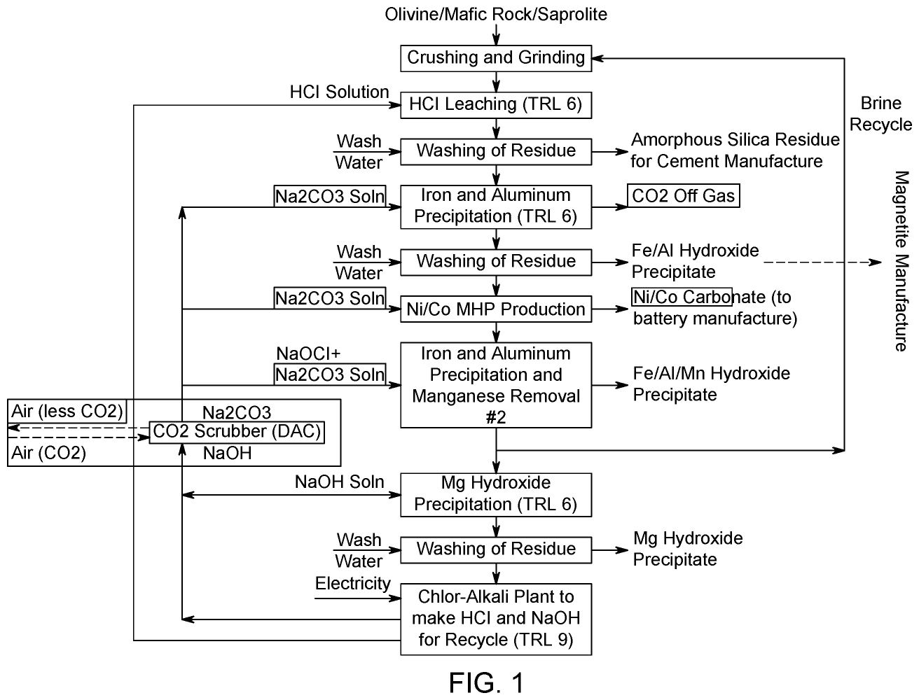

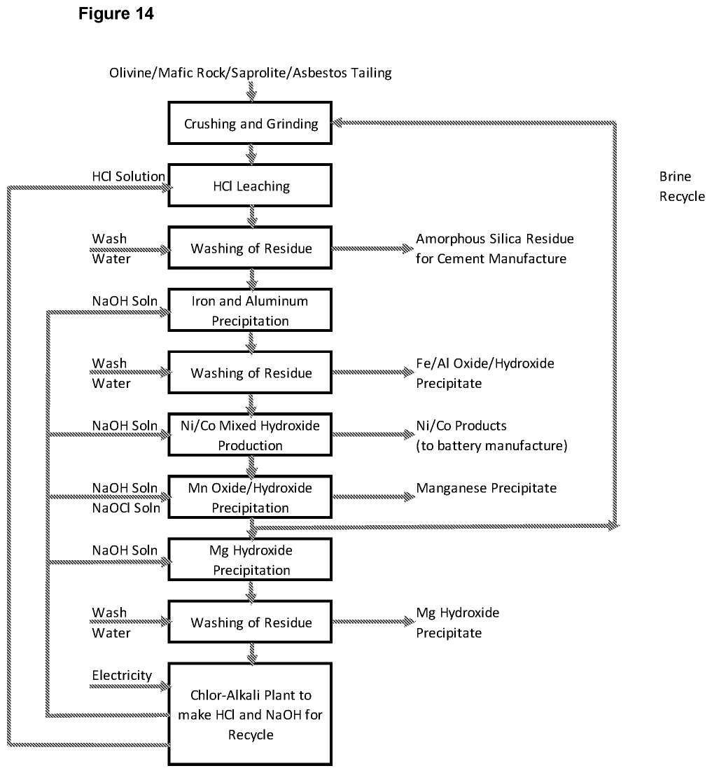

FIGS. 1 and 14 illustrate processes in which metal values are leached from a comminuted (“crushing and grinding”) mineral feedstock with an acid leachant (“HCl leaching”), to produce a solid siliceous residue (“Amorphous Silica Residue for Cement Manufacture”) and a loaded leach solution. As illustrated, the residue may be washed. Crushing and grinding in a recycled brine solution containing a variety of chloride or sulfate salts, such as magnesium and sodium salts, may be carried out so as to avoid or minimize the need for the addition of non-brine water. HCl acid leaching may be carried out at relatively high acid concentrations, such as 30-36% HCl by weight in water—a typical product from an HCl production facility attached to a chlor-alkali plant.

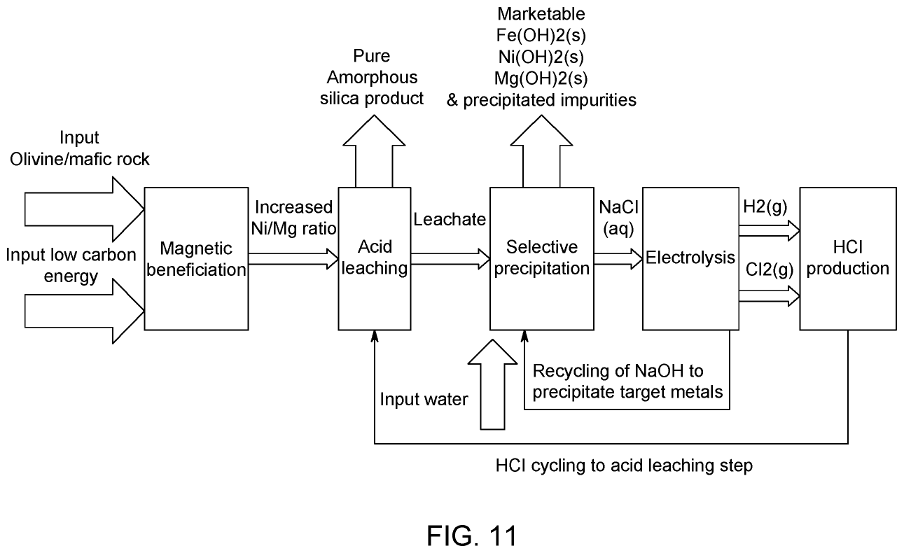

As illustrated in FIG. 11, in an embodiment of the invention, the ferromagnetic content of the crushed ore may be modulated using a magnetic separator, for example so as to increase or decrease the iron and nickel hydroxide products of the process. For example, with an (ultra)mafic sand input comprising olivine or wollastonite, the ratio of MgSiO₄ and CaSiO₄ content to nickel and iron may be optimised via magnetic separation. In a further alternative, a resin in leach process may be used to selectively remove nickel content in the acidic leach prior to selective precipitation steps, to obtain a purified nickel product.

Conditions for leaching may include a leaching temperature of from 80° C. to boiling point, to 115° C. or higher. Acid addition during HCl leaching may for example range from 500 to 1000 kg HCl per dry tonne of solid feed, varying with the chemical composition of the feed. Leaching times may for example be for effective residence times of from 1 hour to 8 hours. Leaching may for example be carried out in a single stage or two or more countercurrent stages. In a single stage process, the acid and ore are added together and allowed to react at a leaching temperature to completion. In a multistage leach, fresh ore is contacted with partly reacted solution so as to maximize the use of the acid (low terminal acidity) and in the second or subsequent stage, the partly leached ore (from the first stage) is contacted with high acid to maximize extraction of Mg/Ni/Co/Fe, etc. The multistage process may involve additional solid/liquid separation steps to ensure countercurrent movement of solids and liquids.

The raw materials for the present processes may contain a variety of silicate minerals including magnesium, iron, nickel and cobalt and minor impurity elements. The chemistry of acid leaching, with HCl, may therefore be represented the following reactions:

Mg₂SiO₄+4HCl=2MgCl₂+SiO₂+2H₂O

Ni₂SiO₄+4HCl=2NiCl₂+SiO₂+2H₂O

Fe₂SiO₄+4HCl=2FeCl₂+SiO₂+2H₂O

Other minerals present in source materials such as iron oxides or aluminum oxides may also react with HCl to form additional salts in solution:

FeO(OH)+3HCl=FeCl₃+2H₂O

AlO(OH)+3HCl=AlCl₃+2H₂O

Natural mineral source materials are of course not pure compounds, so that the source minerals my contain a variety of elements (eg. Mg, Ni, Co, Fe in one silicate mineral) and may be hydrated or weathered. Geological descriptions of suitable feed materials include: nickel saprolite ores, olivine ores, and asbestos ores and tailings.

The product of HCl leaching is a weakly acidic solution containing various chloride salts. A silica rich residue is recovered as a solid product. This residue may for example be washed to remove salts and excess acid with fresh water, and/or alkalized (alkali conditioning) with a base to adjust pH, and then directed to cement manufacture where the silica may be used as a replacement for other materials (thus lowering the carbon intensity of cement manufacture) and as a strengthener to improve the yield strength of concrete, with the silica acting as a supplementary cementitious material (SCM) in a high performance concrete.

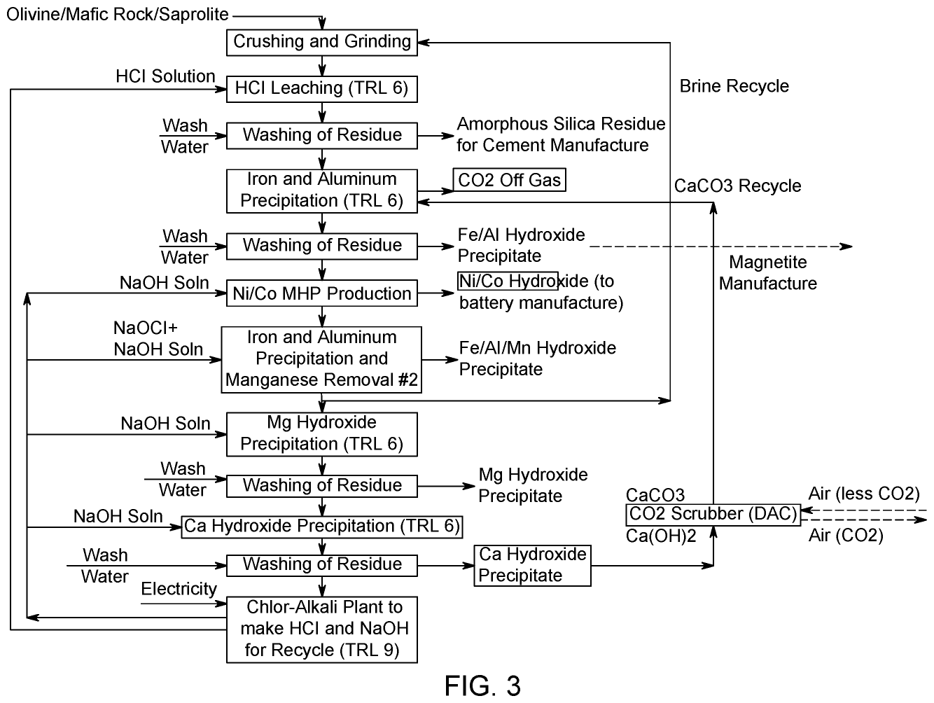

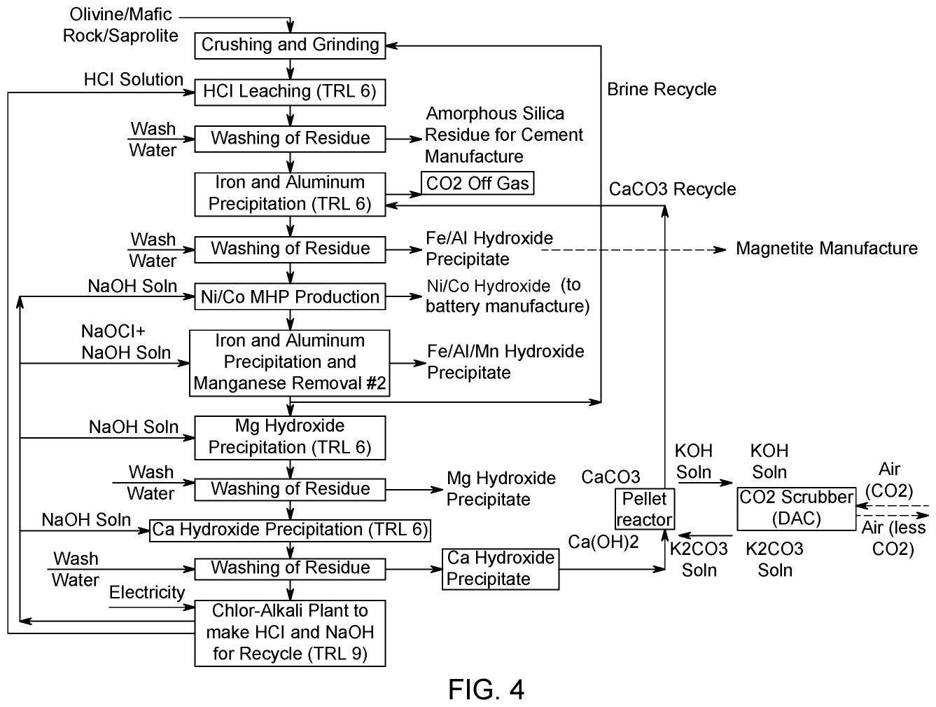

Iron and/or aluminum are precipitated (“Iron and Aluminum Precipitation”) from the loaded leach solution with an alkali hydroxide (NaOH as illustrated in FIG. 14) an alkali metal carbonate or bicarbonate precipitant (Na₂CO₃ as illustrated in FIG. 1) or an alkaline-earth metal carbonate (FIGS. 3 and 4). When Na₂CO₃ is used as a precipitant, this produces a carbon dioxide off gas (“CO₂ Off Gas”), an Fe/Al depleted solution and an iron and/or aluminum hydroxide or oxide precipitate product (“Fe/Al Hydroxide Precipitate” as illustrated, comprising magnetite in select embodiments). As illustrated, the residue is washed to provide the precipitate. When an alkali hydroxide (e.g. KOH or NaOH) is used as the precipitant, the iron and aluminum content in the solution is generally precipitated as a mix of oxide and hydroxide solids by raising the pH with an alkali hydroxide (KOH or NaOH) solution. The NaOH solution may for example be added as a 50% solution, and may be diluted with recycled brine solution for process convenience and enhanced pH control (it may be hard to control pH when adding a very strong base). The added NaOH neutralizes excess acid and precipitates Fe/Al and other trivalent cations if present:

HCl+NaOH=NaCl+H₂O

FeCl₃+3NaOH=FeO(OH)+3NaCl+H₂O

2FeCl₃+6NaOH=Fe₂O₃(hematite)+6NaCl+3H₂O

AlCl₃+3NaOH=AlO(OH)+3NaCl+H₂O

2AlCl₃+6NaOH=Al₂O₃+6NaCl+3H₂O

CrCl₃+3NaOH=CrO(OH)+3NaCl+H₂O

2CrCl₃+6NaOH=Cr₂O₃+6NaCl+3H₂O

The pH adjustment may for example be conducted with stoichiometric amounts of alkali hydroxide. Over-addition of NaOH may result in precipitation of Ni/Co (undesirable) so control of base addition must be maintained. The Fe/Al precipitation temperature may for example be 75° C. to boiling point. Seed (precipitate) may be recycled, for example in the form of hematite, to ensure growth of suitably sized particles, and materials, for enhanced solid/liquid separation. An initial mineral seed, such as hematite, may be used to initiate the process of precipitating a select material, such as hematite. Fe/Al precipitation time may for example be 1 to 8 hours. NaOH may for example be added progressively through precipitation tanks (continuous) so as to enhance precipitation of coarser/separable precipitates. The Fe/Al precipitation product may be separated by S/L separation and washed.

The Fe/Al precipitation residue may for example be treated to form commercial products, such as hematite. For example, drying and partial reduction may be used to form magnetite and a mixed Al/Cr oxide. The magnetite can be separated using magnetic separation and the Al/Cr oxide can be sold as a product for the refractory market.

Nickel and cobalt may be selectively recovered in a variety of ways. In an HCl based leaching process, Ni and Co will be present in solution as NiCl₂ and COCl₂ salts, and these salts can be recovered by ion exchange, for example using a Dow M4195 resin to extract Ni and Co in a Na-form resin. The resin can then be stripped with HCl solution to form a strong, purified solution of Ni/Co chloride salts. The resin may then be treated with NaOH solution after acid stripping to return to the resin “loading” step.

In select embodiments, the recovery of Ni/Co is by way of a mixed hydroxide precipitate (MHP). This can be done directly from the solution coming from the iron precipitation step, or can be effected starting with the ion exchange eluant containing nickel and cobalt chloride. In these processes, a solution of sodium hydroxide is added to from the precipitates:

NiCl₂+2NaOH=Ni(OH)₂+2NaCl

CoCl₂+2NaOH=Co(OH)₂+2NaCl

Other metals may also precipitate with the Ni/Co in minor amounts. For example Mn, Fe (remaining iron in solution).

The selectivity of Ni/Co MHP precipitation can be enhanced by using two stage MHP precipitation, in which a second stage precipitate is recovered and recycled to the first stage or to the discharge from the main leaching step (where acid is present to redissolve the Ni/Co and other metals from the second stage leach).

The mixed hydroxide precipitate may be recovered by S/L separation and washing. A pressure filter may be used with a “squeeze” cycle to minimize the entrained moisture in the washed Ni/Co MHP cake prior to shipping.

The Ni/Co MHP precipitation may be carried out between 25-90° C. with a terminal pH in the range of 5-8. The addition of base can also be controlled by stoichiometry rather than, or in addition to, pH. The Ni/Co MHP precipitation time may for example be 1-8 hours. Seed recycling may be used to maximize particle size and minimize contamination. The Ni/Co MHP process (as in all steps) may be conducted continuously.

As illustrated in FIG. 1, in an alternative embodiment nickel and/or cobalt may be precipitated from the Fe/Al depleted solution with a second alkali metal carbonate or bicarbonate precipitant (Na₂CO₃ as illustrated), to produce a Ni/Co depleted solution and a nickel and/or cobalt carbonate precipitate product (“Ni/Co Carbonate (to battery manufacture)”).

Most of the iron and aluminum are removed from solution in the first iron removal step. Manganese is generally not removed from solution in either the initial iron control or the Ni/Co MHP precipitation steps. Accordingly, a second stage of iron precipitation may be implemented with increased pH so as to maximize the removal of iron with an oxidant added to oxidize Mn and Fe to facilitate more complete removal and purification of all species. Suitable oxidants include gaseous chlorine or sodium hypochlorite (NaOCl). Example reactions include:

2FeCl₂+NaOCl+4NaOH=2FeO(OH)+5NaCl+H₂O

MnCl₂+NaOCl+2NaOH=MnO₂+3NaCl+H₂O

AlCl₃+3NaOH=AlO(OH)+3NaCl+H₂O

Conditions for iron and/or aluminum and/or manganese scrubbing may be designed to maximize precipitation of the impurity elements while minimizing formation of magnesium hydroxide. The oxidant (eg. NaOCl) may be added so as to achieve a suitably high oxidation/reduction potential (ORP) to maximize the oxidative removal of Fe/Mn. Scrubbing temperature may for example be 25° C. to the boiling point. As in other precipitation steps, seed recycle can be used to improve performance. Scrubbing time may for example be 1 to 8 hours.

Alternatively, as illustrated in FIG. 1, iron and/or aluminum and/or manganese may be scrubbed from the Ni/Co depleted solution with a third alkali metal carbonate or bicarbonate precipitant (also Na₂CO₃ as illustrated) and an oxidant, such as the illustrated sodium hypochlorite, to produce an Fe/Al/Mn depleted solution and an iron and/or aluminum and/or manganese hydroxide precipitate product (“Fe/Al/Mn Hydroxide Precipitate”). As illustrated, brine comprising the Fe/Al/Mn depleted solution may be recycled to the comminuting step to provide the comminuted mineral feedstock.

Magnesium remaining in solution may be precipitated from the Fe/Al/Mn depleted solution with an alkali hydroxide precipitant (NaOH as illustrated), to produce a Mg-depleted solution and a magnesium hydroxide precipitate product (“Mg Hydroxide Precipitate”):

MgCl₂+2NaOH=Mg(OH)₂+2NaCl

This may for example be carried out by adding NaOH to MgCl₂ solution, or by reversing the order of addition. In either case, the process may be carried out so as to provide a near complete removal of Mg as Mg(OH)2 from solution. This generally requires a near stoichiometric addition of NaOH.

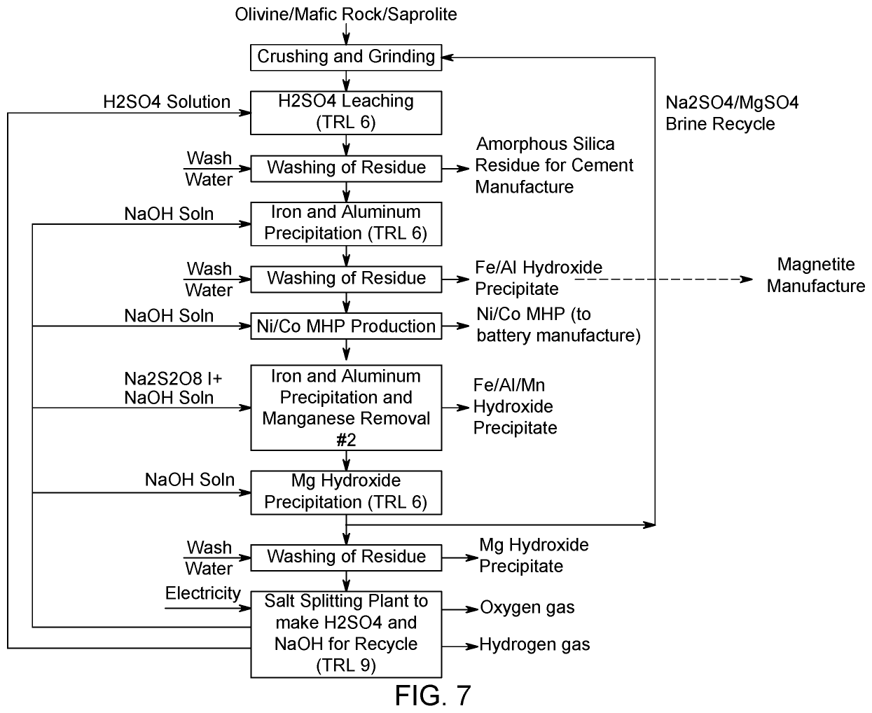

The Mg-depleted solution may then be subjected to further purification, for example in an ion exchange resin separation step, or sent directly to an electrolysis to produce the alkali hydroxide precipitant and the acid leachant (in FIG. 1, “Chlor-Alkali Plant to make HCl and NaOH for Recycle”, in FIG. 7 “Salt Splitting Plant to make H₂SO₄ and NaOH for Recycle”). Standard chloralkali brine pretreatments may be carried out on the Mg-depleted solution to provide a higher purity Mg-depleted brine, for example essentially free of undesirable solids and ions, for example involving brine saturation/evaporation and softening, for example by primary and polish filtration steps and high-performance ion exchange softening. In an HCl based extraction process, the final Mg-depleted solution is NaCl_{(aq)} with some minor contaminants in solution. This NaCl_{(aq)} solution is directed to a chlor-alkali plant for manufacture of NaOH, Cl₂ and H₂, involving conventional steps, with the Cl₂ and H₂ available to be burned and water-scrubbed to form a strong HCl solution for recycle to leaching. Excess heat from Cl₂ and H₂ combustion may for example be recovered as steam and used to evaporate excess water from solution.

As illustrated in FIG. 1, carbon dioxide may be scrubbed from a CO₂ containing gas (“Air” as illustrated) by treating the CO₂ containing gas with a scrubbing solution comprising the alkali hydroxide precipitant (NaOH as illustrated), to produce one or more of the alkali metal carbonate or bicarbonate precipitants (Na₂CO₃ as illustrated).

In the foregoing process, the step of scrubbing carbon dioxide from the CO₂ containing gas may include a crystallisation step to precipitate Na₂CO₃ hydrates from the scrubbing solution, the alkali hydroxide precipitant being NaOH. The solid Na₂CO₃ crystallizer product may then be directed to provide one or more of the alkali metal carbonate or bicarbonate precipitants.

In accordance with the foregoing, as illustrated in FIG. 1, processes are provided for using NaOH in Direct Air Capture (DAC) of carbon dioxide. This may for example be carried out in addition to CO₂ capture mediated in alternative embodiments by Mg(OH)₂. NaOH solutions (for example at 50% NaOH arising from chlor-alkali plant production) can be used to capture CO₂ directly from the air using air-liquid contacts. The product formed by this treatment is sodium carbonate Na₂CO₃ or Na₂CO₃·10H₂O (decahydrate). The overall reaction for forming these products may include:

2NaOH+CO_{2(g)}=Na₂CO₃₍ₛ₎+H₂O

2NaOH+CO_{2(g)}+9H₂O=Na₂CO₃·10H₂O₍ₛ₎

Sodium carbonate decahydrate is stable at low temperature but can be dehydrated by heating to a suitable temperature with the release of the hydrating water. The sodium carbonate (anhydrous or decahydrate) can be used as an alternate precipitant to NaOH in alternative embodiments of the process. The following simplified reactions again summarize the alternate reactions (just using Na₂CO₃):

2HCl+Na₂CO₃=2NaCl+H₂O+CO_{2(g)}

2FeCl₃+3Na₂CO₃=Fe₂O₃+6NaCl+3CO_{2(g)}

NiCl₂+Na₂CO₃=NiCO₃+2NaCl

COCl₂+Na₂CO₃=COCO₃+2NaCl

MgCl₂+Na₂CO₃=MgCO₃+2NaCl

The CO_{2(g)} formed by neutralization of HCl and FeCl₃ (in the primary neutralization part of the process) can be captured from the outlet of a covered tank and directed to CO₂ recovery and ultimately storage—for example by introducing to an underground formation. This CO_{2(g)} represents effective decarbonization of the atmosphere.

The production of a NiCO₃ and COCO₃ product mix provides the option of replacing a mixed hydroxide product with mixed carbonate product. This may have some advantages to produce a drier product (less moisture for shipping), a purer product and may still be used as a precursor for battery material manufacture, for example a mixed carbonate can be leached in sulfuric acid and purified to form high purity battery salts. The carbonate in these forms (NiCO₃ and CoCO₃) may be recovered as CO₂(g) in facilities that conduct acid releach of mixed Ni/Co products. Again, a sealed tank and CO₂ gas handling would generally be required.

The MgCO₃ product may be used as a final product for the purposes of carbon sequestration. Alternately, the MgCO₃ can be calcined to produce MgO for ocean alkalinity enhancement and the CO₂ from the calcination could be collected and again directed as a high concentration gas to underground storage (or any similar scheme).

In alternative embodiments, Na₂CO₃ may be used for all selective precipitation steps except the precipitation of Mg(OH)₂ by NaOH, so as to maintain a (1) marketable specialty chemical, and (2) an additional CO₂ capturing compound.

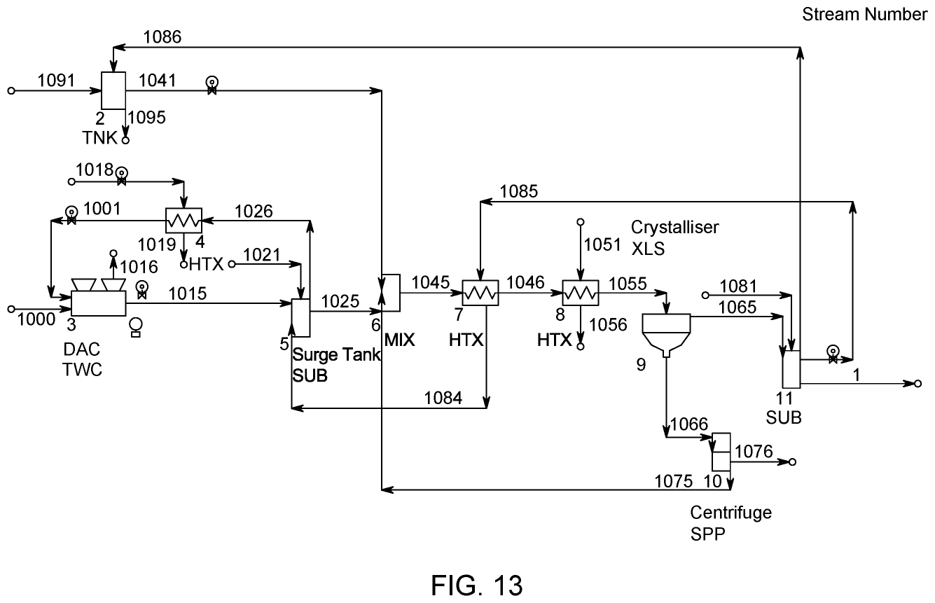

FIG. 13 illustrates a DAC circuit configuration, in which Stream 1000 is the air going to the Direct Air Capture scrubber. Stream 1001 is the scrubbing solution containing NaOH and Na₂CO₃. Stream 1016 is the CO₂ depleted air and stream 1015 is the solution, enriched in sodium carbonate. Heat Exchange 4 (HTX 4) is used to maintain the solution temperature through the DAC circuit. The solution tends to evaporate water. Stream 1026 is the scrubbing solution which after heating becomes Stream 1001. The heat is applied with steam in Stream 1018 and the condensate is contained in Stream 1019. Surge Tank 5 receives Stream 1015 and Stream 1084. Stream 1084 provides NaOH for the DAC reaction. Stream 1021 provides for water addition to the DAC system to compensate for evaporation in the DAC unit. Stream 1025 is taken from the DAC circuit and combined with Stream 1041 and stream 1075 to form Stream 1045. HTX 7 is used to cool stream 1045 and heat stream 1085. HTX 8 is a chiller that cools the Stream 1045 prior to entry into the crystallizer.

In the DAC circuit of FIG. 13, the crystallizer is unit operation 9. Sodium carbonate decahydrate is recovered by centrifugation of the crystallizer slurry. The overflow from the crystallizer is directed to a tank (SUB 11). Water (Stream 1081) is again added to maintain the water balance. Part of the solution is directed back to Surge tank 5 (Stream 1085). The balance goes to TNK 2 (Stream 1086). There is a provision for a bleed from SUB 11, but in practice this is typically negligible. TNK 2 is where the new caustic is added (Stream 1091). The caustic addition has the effect of reducing the Na₂CO₃ solubility in solution and helps drive the crystallizer chemistry. The solubility of Na₂CO₃ varies in a known way with temperature and NaOH concentration. The crystallizer is therefore operated under conditions of low temperature and elevated NaOH concentration to maximize the crystallization of sodium carbonate. Note that below ˜30° C., the form of Na₂CO₃ is Na₂CO₃·10H₂O (sodium carbonate decahydrate). In sum, the NaOH—Na₂CO₃ solution can be crystallized to recover Na₂CO₃·10H₂O by addition of NaOH and cooling (chiller). The DAC mini-circuit has to be maintained at a higher temperature (hence steam heating HTX 4) to ensure high solubility of Na₂CO₃. The crystallizer circuit makes use of a chiller to reach low temperatures to crystallize and remove Na₂CO₃.

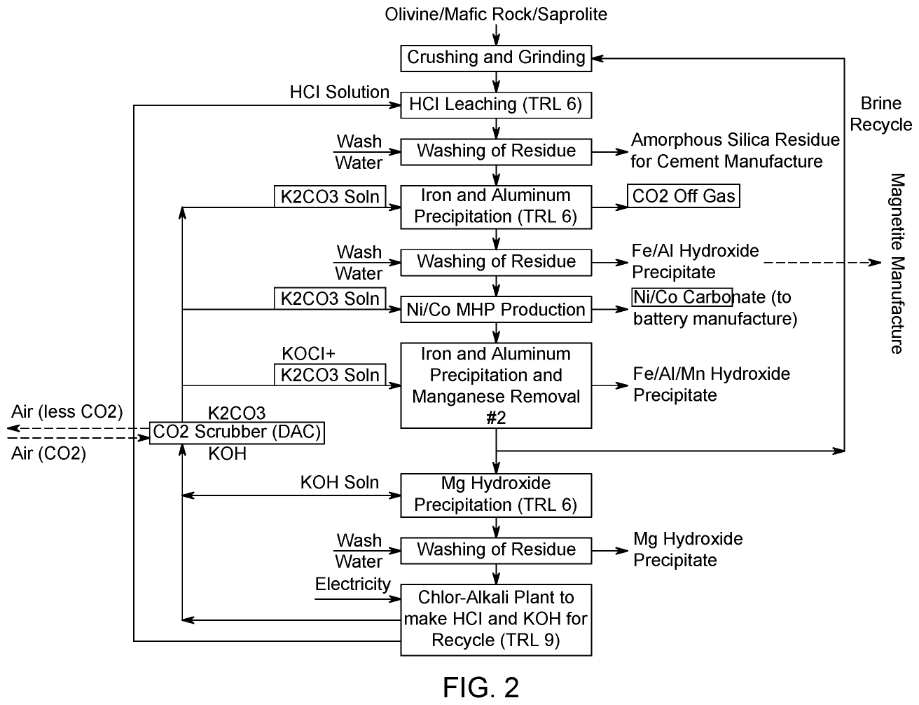

FIG. 2 illustrates a process analogous to the process illustrated in FIG. 1, with potassium compounds in place of the sodium compounds of FIG. 1.

FIG. 3 and FIG. 4 illustrate alternative embodiments which involve precipitating calcium from the Mg-depleted solution with a fourth alkali metal hydroxide precipitant (NaOH as illustrated), to produce a Ca-depleted solution and a calcium hydroxide product. The calcium hydroxide product is then available for carbon sequestration reactions, for example by generating an alkaline-earth metal carbonate precipitant for the iron and/or aluminum precipitation step by treating the calcium hydroxide product with a carbon source, such as air (FIG. 3) or a metal carbonate that is in turn derived from KOH-mediated carbon capture (FIG. 4). In these processes, the Ca-depleted solution is subjected to electrolysis to produce one or more of the first, second, third or fourth alkali metal hydroxide precipitants and the acid leachant.

The alkali hydroxide precipitant may accordingly be NaOH (FIGS. 1, 3 and 4) or KOH (FIG. 2). The process acid leachant as illustrated is HCl. These products may be produced in a chloralkali process.

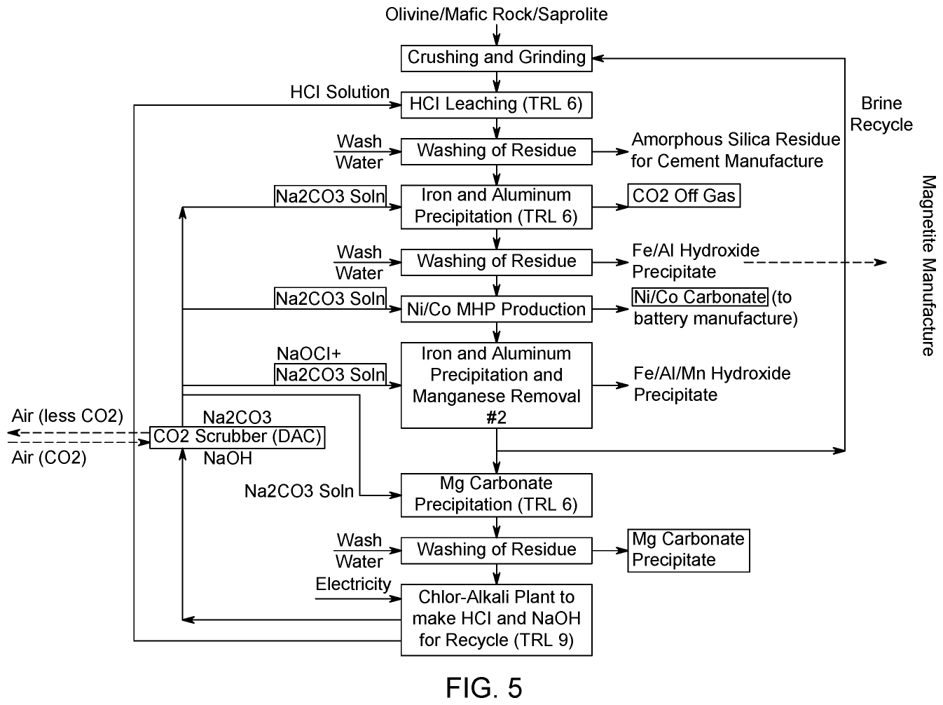

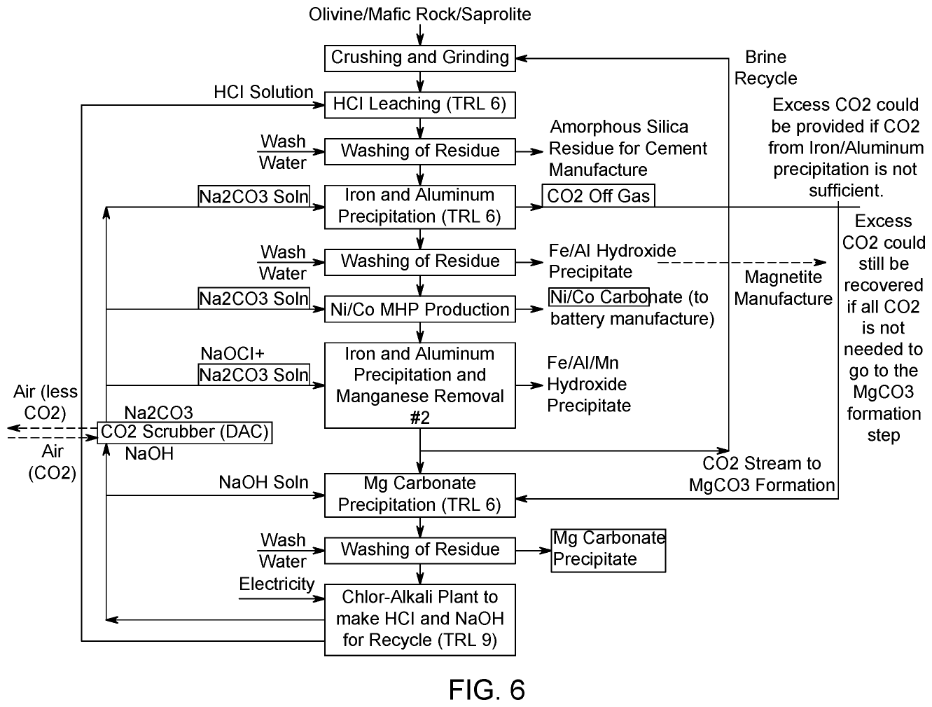

FIG. 5 and FIG. 6 illustrate alternative embodiments, in which alternative pathways are used to form MgCO₃ rather than Mg(OH)₂ in the magnesium precipitation step. These embodiments reflect adaptations related to the use of Mg(OH)₂ from the present processes for: (1) direct air capture (DAC) of CO₂ to form MgCO₃; or, (2) ocean alkalinity enhancement (OAE) to form Mg(HCO₃)₂ by direct addition of Mg(OH)₂ to the ocean environment. The use of Mg(OH)₂ to form MgCO₃ by contact with air containing CO₂ can in some circumstances suffer from unfavourable kinetics. The embodiments illustrated in FIG. 5 and FIG. 6 accordingly provide alternative routes to forming MgCO₃ in approaches that may be adapted to optimize carbon sequestration.

FIG. 5 illustrates a process in which MgCO₃ is formed by direct neutralization of the Fe/Al/Mn depleted solution, so that Na₂CO₃, for example produced in and recovered from a direct air capture (DAC) process, reacts with MgCl_{2(aq)} in the Fe/Al/Mn depleted solution to form MgCO₃₍ₛ₎:

MgCl₂+Na₂CO₃=MgCO₃+2NaCl

In select embodiments, essentially the full amount of NaOH produced by the chloralkali process is directed to the DAC system to produce Na₂CO₃ from CO₂ captured directly from the atmosphere. In such a process, sufficient Na₂CO₃ is produced to provide the alkali metal precipitant for all aspects of the process, including recovery of MgCO₃. In this way, sorbent regeneration for DAC, i.e. NaOH, is combined with long term mineralisation of the CO₂. MgCO₃ mineralisation thereby creates carbon negative products in the form of carbonates, that may for example be used as filler or construction aggregate.

FIG. 6 illustrates an alternative process involving the formation of MgCO₃ by direct addition of CO₂ gas, with addition of NaOH, to the Fe/Al/Mn depleted solution, to react with MgCl_{2(aq)} in solution to form MgCO₃₍ₛ₎:

MgCl₂+2NaOH+CO_{2(g)}=MgCO₃+2NaCl+H₂O

As illustrated in FIG. 6, a portion of NaOH from the chloralkali process may be directed to the Mg precipitation stage, together with CO_{2(g)} (for example recovered as a CO₂ off gas from iron and aluminum precipitation with Na₂CO₃), forming MgCO₃ in-situ. Alternatively, CO_{2(g)} for Mg carbonate precipitation may come from sources external to the present process.

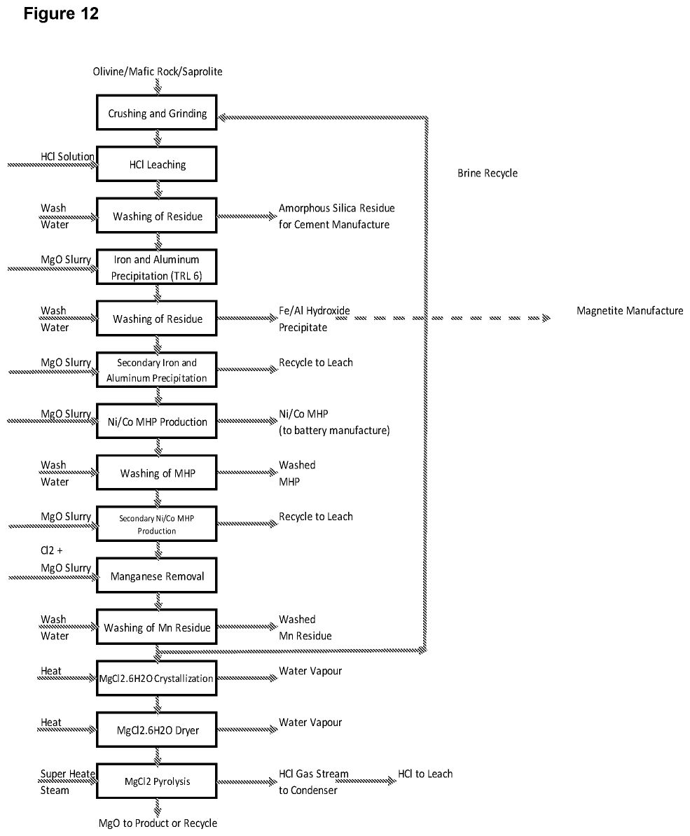

FIG. 12 illustrates an embodiment in which a MgCl₂ salt is produced, and pyrohydrolyzed to produce MgO as a base for recycle, for use as an alkaline-earth metal precipitant, as well optionally for use as a product, for use for example in carbon sequestration, and for use to produce HCl for recycle to the leaching step.

The process of FIG. 12 begins with crushing and grinding of feedstock in a recycled brine solution containing a variety of chloride salts, including magnesium chloride and sodium chloride. The recycle of a brine solution avoids or reduces the necessity for the addition of water.

Crushing and grinding is followed in the process of FIG. 12 by HCl leaching. The leaching process may for example uses HCl at high strength (typically 30-36% HCl by weight in water—for example provided as a product from an HCl production facility associated with a chlor-alkali plant). The raw feedstock materials may for example contain a variety of silicate minerals including magnesium, iron, nickel and cobalt and minor impurity elements. The chemistry of leaching reactions may for example include the following reactions:

Mg₂SiO₄+4HCl=2MgCl₂+SiO₂+2H₂O,

Ni₂SiO₄+4HCl=2NiCl₂+SiO₂+2H₂O,

Fe₂SiO₄+4HCl=2FeCl₂+SiO₂+2H₂O.

Other minerals present such as iron oxides or aluminum oxides may also react with HCl to form additional salts in solution:

FeO(OH)+3HCl=FeCl₃+2H₂O,

AlO(OH)+3HCl=AlCl₃+2H₂O.

Natural minerals are generally not pure compounds, and mineral feedstock minerals my for example contain a variety of elements (eg. Mg, Ni, Co, Fe in one silicate mineral) and may be hydrated or weathered. Geological descriptions of suitable feed materials include: nickel saprolite ores, olivine ores, and/or asbestos ores and tailings.

Conditions for leaching may for example maintaining a leaching temperature, for example a leaching temperature above ambient, for example 80° C. to the boiling point (e.g. up to 115° C. or higher). Acid addition may for example range from 500 to 1000 kg HCl per dry tonne of solid feed, and will generally vary with the chemical composition of the feed. The leaching time may for example vary from 1 hour to 8 hours. Leaching may for example be carried out in a single stage or two stage countercurrent. In this context, single stage means that the acid and ore are added together and allowed to react at temperature to completion; and, two stage means that fresh ore is contacted with partly reacted solution so as to maximize the use of the acid (low terminal acidity) and in the second stage, the partly leached ore (from the first stage) is contacted with high acid to maximize extraction of Mg/Ni/Co/Fe, etc. The two stage process requires an additional solid/liquid separation step to ensure countercurrent movement of solids and liquids.

The product of HCl leaching is generally a weakly acidic solution containing various chloride salts. A silica rich residue may be recovered as a solid product. This residue may be washed to remove salts and excess acid with fresh water and then may for example be directed to cement manufacture where the silica is used as a replacement for other materials (thus lowering the carbon intensity of cement manufacture) and a strengthener to improve the yield strength of concrete (high performance concrete).

Iron and aluminum values in the solution may be precipitated as a mix of oxide and hydroxide solids by raising the pH with a MgO slurry. The MgO may for example be added as a 20% slurry. The MgO is added so as to neutralize the excess acid and precipitate Fe/Al and other trivalent cations if present:

2HCl+MgO=MgCl₂+H₂O,

2FeCl₃+3MgO+H₂O=2FeO(OH)+3MgCl₂,

2FeCl₃+3MgO=Fe₂O₃+3MgCl₂,

2AlCl₃+3MgO+H₂O=2AlO(OH)+3MgCl₂,

2AlCl₃+3MgO=Al₂O₃+3MgCl₂,

2CrCl₃+3MgO+H₂O=2CrO(OH)+3MgCl₂,

2CrCl₃+3MgO=Cr₂O₃+3MgCl₂.

The pH adjustment for iron and aluminum precipitation may for example be conducted with stoichiometric amounts of MgO. Overaddition may result in precipitation of Ni/Co (undesirable) so careful control of addition may be maintained. The temperature for iron and aluminum precipitation may for example be from 75° C. to the boiling point. Seed (precipitate) may be recycled to facilitate growth of suitable sized particles for enhanced solid/liquid separation. Iron and aluminum precipitation time may for example be 1 to 8 hours. MgO slurry may be added progressively through precipitation tanks (continuously) so as to enhance precipitation of coarser/separable precipitates. The iron and aluminum precipitation product may be separated by S/L separation and optionally washed. The residue may be treated to form commercial products. For example, drying and partial reduction may be used to form magnetite and a mixed Al/Cr oxide. The magnetite can be separated using magnetic separation and the Al/Cr oxide can be sold as a product for the refractory market.

A second stage of iron/aluminum removal can be added after the primary stage. The purpose of this stage is to remove as much as possible the Fe/Al/Cr from solution to ensure good quality MHP. The second stage iron precipitate may be recycled back to leach to ensure redissolution and high recovery of any co-precipitated Ni/Co.

Nickel and cobalt recovery can then be carried out in a variety ways, for example by producing a mixed hydroxide precipitate. This can be done directly from the solution coming from the iron precipitation or from a solution obtained by pre-concentration of the nickel and cobalt (eg. ion exchange or solvent extraction).

A slurry of MgO may be added to form the precipitates:

NiCl₂+MgO+H₂O=Ni(OH)₂+2NaCl,

COCl₂+MgO+H₂O=Co(OH)₂+2NaCl.

Other metals may also precipitate with the Ni/Co in minor amounts. For example Mn, Al, Fe (remaining iron in solution). The Ni/Co precipitation may for example be carried out between 25-90° C. and terminal pH may for example be in the range of 5-8. Particularly in the event that pH measurement is difficult in a strong salt solution, the addition can also be controlled by stoichiometry. Ni/Co precipitation time may for example be 1-8 hours. Seed recycling may be used to maximize particle size and minimize contamination. The Ni/Co precipitation process (as in all steps) may be conducted continuously. A second stage precipitation of mixed hydroxide may be used to facilitate high recovery of nickel and cobalt. In this way, the selectivity of MHP precipitation can be enhanced by using two stage MHP precipitation. The second stage precipitate is recovered and recycled to the first stage or to the discharge from the main leaching step (where acid is present to redissolve the Ni/Co and other metals from the second stage leach).

The mixed hydroxide precipitate may be recovered by S/L separation and optional washing. A pressure filter may for example be used with a “squeeze” cycle to minimize the entrained moisture in the washed MHP cake prior to shipping.

Manganese removal may be carried out so as to enable the production of a Mn-free MgO product by pyrohydrolysis. Manganese may for example be oxidized and precipitated as MnO₂:

MnCl₂+Cl₂=MnCl₄,

MnCl₄+2MgO=MnO₂+2MgCl₂.

Subsequent steps, as illustrated in FIG. 12, involve acid regeneration and production of MgO from the spent solution. After manganese is removed from solution, the solution may predominantly be magnesium chloride. The process may then employ a series of steps to recover magnesium oxide and hydrochloric acid.

Crystallization of MgCl₂·6H₂O may for example be carried out in an evaporation pond or in an engineered crystallization reactor. If the crystallization reactor operates at higher temperature a lower hydrate may be formed. Drying of the MgCl₂·6H₂O may for example be carried out using hot air (heated by steam) to form MgCl₂·4H₂O and then MgCl₂·2H₂O and possibly MgCl(OH). Calcination, for example at 600° C., of the dried salt may be carried out so as to form MgO and HCl(g):

MgCl₂(aqueous)+6H₂O=MgCl₂·6H₂O

MgCl₂·6H₂O=MgCl₂·4H₂O+2H₂O(g)

MgCl₂·4H₂O=MgCl₂·2H₂O+2H₂O(g)

MgCl₂·2H₂O=MgCl(OH)+HCl(g)+1.5H₂O(g)

MgCl(OH)=MgO+HCl.

HCl product may be scrubbed and condensed from off gases from drying and calcination, and recycled back to the main leach process.

The MgO product may for example be used as a slurry in recycle for neutralization (as discussed above) or alternately becomes a final product. The MgO product may for example be used for carbon dioxide capture (see Ruhaimi et al., 2021).

Reactions in various stages of the present process may be further represented as follows:

### Neutralization

Alkali hydroxide: 2HCl+2NaOH=2NaCl+2H₂O

Alkali metal carbonate: 2HCl+Na₂CO₃=2NaCl+H₂O+CO_{2(g)}

### Iron Precipitation

Alkali hydroxide:2FeCl₃+6NaOH=2FeO(OH)+2H₂O+6NaCl 2FeCl₃+6NaOH=Fe₂O₃(hematite)+6NaCl+3H₂O

Alkali metal carbonate: 2FeCl₃+3Na₂CO₃+H₂O=2FeO(OH)+6NaCl+3CO_{2(g)}

### Nickel Recovery

Alkali hydroxide: NiCl₂+2NaOH=Ni(OH)₂+2NaCl

Alkali metal carbonate: NiCl₂+Na₂CO₃=NiCO₃+2NaCl

### Magnesium Recovery

Alkali hydroxide: MgCl₂+2NaOH=Mg(OH)₂+2NaCl

Alkali metal carbonate: MgCl₂+Na₂CO₃=MgCO₃+2NaCl

Direct CO₂: MgCl₂+2NaOH+CO_{2(g)}=MgCO₃+2NaCl+H₂O

In alternative embodiments, NaHCO₃ may take the place of Na₂CO₃ in reactions in various stages of the present process.

FIGS. 7-10 illustrate processes in which metal values are leached from a comminuted (“crushing and grinding”) mineral feedstock with a sulfuric acid leachant (“H₂SO₄ leaching”), to produce a solid siliceous residue (“Amorphous Silica Residue for Cement Manufacture”) and a loaded leach solution. As illustrated, the residue may be washed.

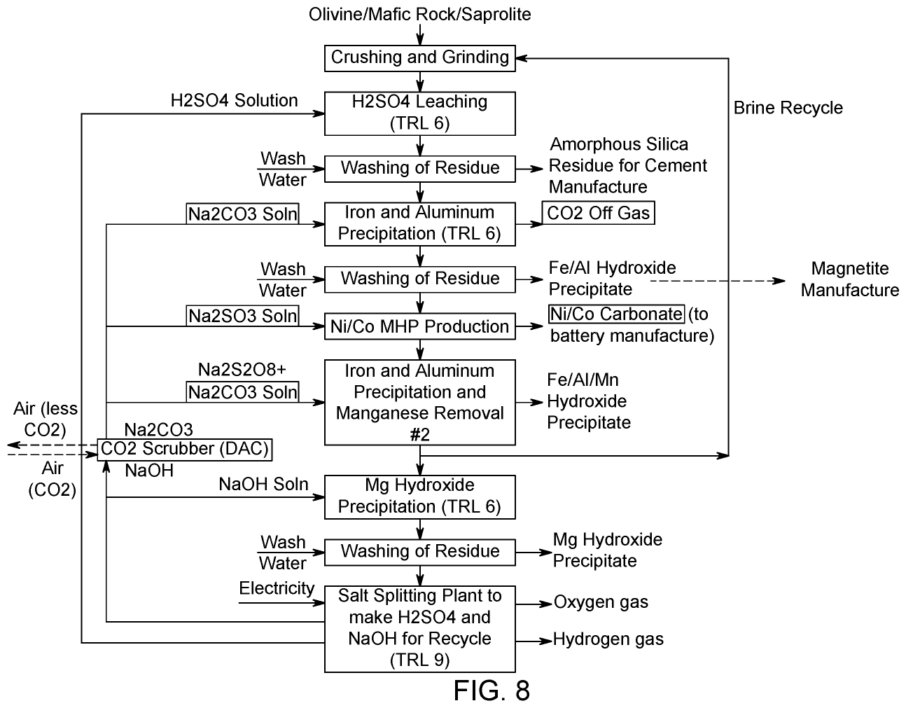

Iron and/or aluminum are precipitated (“Iron and Aluminum Precipitation”) from the loaded leach solution with either an alkali hydroxide precipitant (FIG. 7) or an alkali metal carbonate or bicarbonate precipitant (Na₂CO₃ FIGS. 8-10). Use of the alkali metal carbonate or bicarbonate precipitant produces a carbon dioxide off gas (“CO₂ Off Gas”), an Fe/Al depleted solution and an iron and/or aluminum hydroxide or oxide precipitate product (“Fe/Al Hydroxide Precipitate”, which may be an oxide, such as hematite). The concentrated CO₂ Off Gas may be sequestered using a variety of approaches. As illustrated, the residue may be washed to provide the precipitate, and the precipitate may be used in magnetite manufacture.

Nickel and/or cobalt are precipitated from the Fe/Al depleted solution with the alkali hydroxide precipitant (e.g. NaOH, FIG. 7) or the alkali metal carbonate or bicarbonate precipitant (e.g. Na₂CO₃, FIGS. 8-10), to produce a Ni/Co depleted solution and a nickel and/or cobalt hydroxide (FIG. 1, “MHP”) or carbonate precipitate product (FIGS. 8-10, “Ni/Co Carbonate (to battery manufacture)”).

Iron and/or aluminum and/or manganese may be scrubbed from the Ni/Co depleted solution with the alkali hydroxide precipitant (FIG. 7) or with the alkali metal carbonate or bicarbonate precipitant (FIGS. 8-10, Na₂CO₃) and an oxidant, such as the illustrated sodium persulfate (Na₂S₂O₈), to produce an Fe/Al/Mn depleted solution and an iron and/or aluminum and/or manganese hydroxide precipitate product (“Fe/Al/Mn Hydroxide Precipitate”).

As illustrated, brine comprising the Fe/Al/Mn depleted solution may be recycled to the comminuting step to provide the comminuted mineral feedstock.

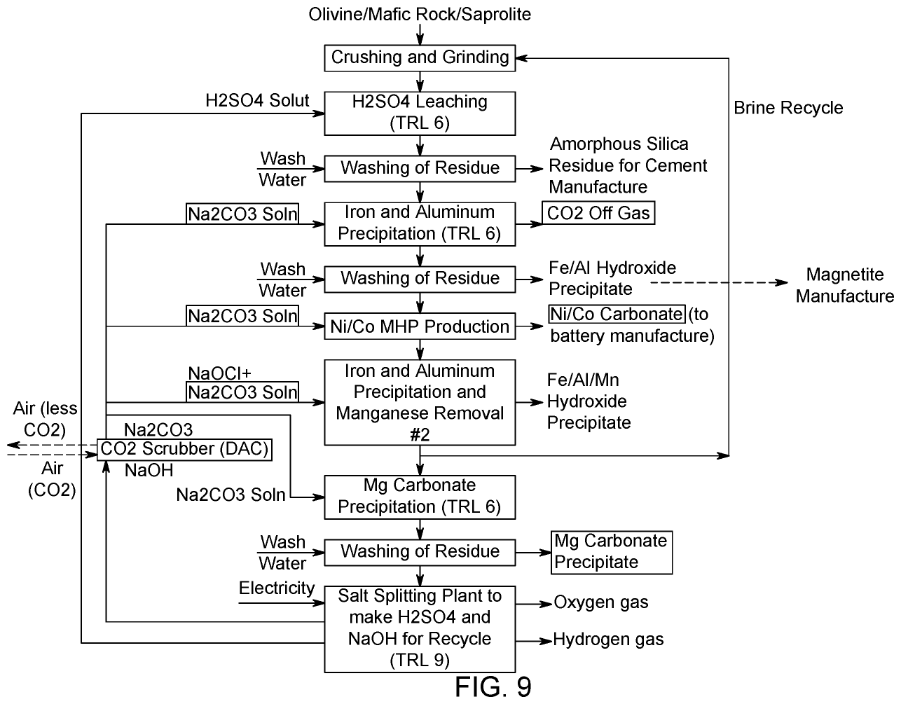

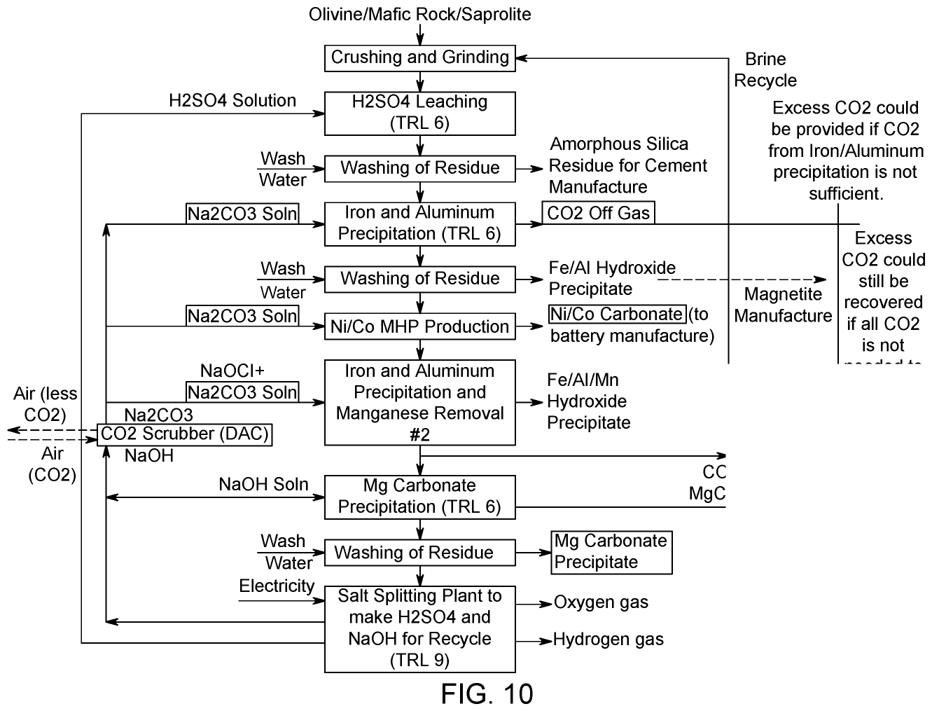

Magnesium may be precipitated from the Fe/Al/Mn depleted solution with the alkali hydroxide precipitant (NaOH as illustrated in FIGS. 7 and 8), or with the alkali metal carbonate or bicarbonate precipitant (FIG. 9) or with a combined feed of the alkali hydroxide precipitant and CO₂ (in a carbon dioxide capture step, FIG. 10) to produce a Mg-depleted solution and a magnesium hydroxide (FIGS. 7 and 8) or carbonate (FIGS. 9 and 10) precipitate product, The Mg-depleted solution may then be subjected to an electrolysis to produce the alkali hydroxide precipitant and the acid leachant (“Salt Splitting Plant to make H₂SO₄ and NaOH for Recycle”).

Carbon dioxide may be scrubbed from a CO₂ containing gas (“Air” as illustrated) by treating the CO₂ containing gas with a scrubbing solution comprising the alkali hydroxide precipitant (NaOH as illustrated), to produce one or more of the first, second, third and fourth alkali metal carbonate or bicarbonate precipitants (Na₂CO₃ as illustrated), for use respectively in i) iron and aluminum precipitation, ii) Ni/Co precipitation, iii) iron and aluminum precipitation with manganese removal, and iv) Mg precipitation.

In the foregoing process, the step of scrubbing carbon dioxide from the CO₂ containing gas may include a crystallisation step to precipitate Na₂CO₃ hydrates from the scrubbing solution, the alkali hydroxide precipitant being NaOH. The solid Na₂CO₃ crystalizer product may then be directed to provide one or more of the alkali metal carbonate or bicarbonate precipitants.

In select embodiments involving carbon capture (DAC), there are two circuits in the system. The first circuit (CO₂ capture), requires low temperature but not too low. In this first circuit, the passage of air evaporates water and hence cools the solution. If the solution cools too much due to this evaporative process, the Na₂CO₃·10H₂O may crystallize in the adsorption circuit (an undesirable outcome), limiting the ability to increase the concentration of sodium carbonate produced by the first circuit. To ameliorate this effect, metered quantities of heat and water are added to the evaporative carbon capture circuit. For the second circuit (crystallization) cooling (or chilling) is used to drive the crystallization of sodium carbonate decahydrate. Optimized process are accordingly provided that minimize heating in the CO₂ capture circuit and minimize cooling in the crystallization circuit. Modeling has revealed that temperature ranges may for example be on the order of 10-20° C. in the CO₂ capture circuit and 0-10° C. in the crystallization circuit. Water is added to the CO₂ capture circuit to make up for evaporative losses. As the ambient temperature and relative humidity of the air changes, the DAC operating conditions may change. In select embodiments, the strong NaOH absorbent solution has a pH of ˜14 (a ˜40 g/L NaOH solution). CO₂ absorption by the NaOH absorbent solution converts NaOH to Na₂CO₃, to provide a Na₂CO₃ loaded solution which has a pH of ˜12-12.5 (i.e. a lower strength base). The Na₂CO₃ loaded solution may then be used as a precipitant in other process steps, in the place for example of an NaOH solution. The use of the Na₂CO₃ loaded solution as a precipitant has a number of surprising features (as revealed by process testing). When Fe is precipitated with the Na₂CO₃ loaded solution, it was surprisingly found that, Na₂CO₃ as a milder base, makes for a more effective and controlled precipitation process for Fe (and Al/Cr). Also, when Ni/Co is precipitated with the Na₂CO₃ loaded solution, a Ni/Co mixed carbonate precipitate is produced which provided an improved mixed product (more crystalline, easier to separate from solution, lower in chloride content than a mixed hydroxide which typically contains elevated chloride, and lower in moisture when filtered.

The process acid leachant as illustrated is H₂SO₄. As such, processes are provided that use of a sulfate based system for treatment of magnesium silicates. In select embodiments, (FIG. 7) H₂SO₄/NaOH/Na₂SO₄ salt splitting is used to produce amorphous silica for cementing, iron residue, mixed nickel and cobalt hydroxide and magnesium hydroxide—which is then available for carbon sequestration. In alternative embodiments, various direct air carbon capture (DAC) steps are integrated into the sulfate system (FIGS. 8-10). In particular, FIG. 8 illustrates a process wherein a portion of the alkali hydroxide precipitant NaOH is used to remove CO₂ from air. The resulting sodium carbonate is then used in the iron removal and the nickel/cobalt precipitation stages. FIG. 9 illustrates a process in which there is complete use of NaOH for DAC to form Na₂CO₃. The addition of Na₂CO₃ to the Mg precipitation stage results in MgCO₃ precipitation directly for carbon sequestration. FIG. 10 illustrates an alternative embodiment in which the alkali hydroxide precipitant NaOH is combined with CO₂ added directly to the Mg precipitation stage, to form MgCO₃.

Steps in the sulfate process may be characterized by reactions therein, as follows:

### Acid Leaching (Simplified);

Mg₂SiO₄+2H₂SO₄=2MgSO₄+SiO₂+2H₂O

Ni₂SiO₄+2H₂SO₄=2NiSO₄+SiO₂+2H₂O

Co₂SiO₄+2H₂SO₄=2CoSO₄+SiO₂+2H₂O

Fe₂SiO₄+2H₂SO₄=2FeSO₄+SiO₂+2H₂O

MnO₂+2FeSO₄+2H₂SO₄=MnSO₄+Fe₂(SO₄)₃+2H₂O

2FeO(OH)+3H₂SO₄=Fe₂(SO₄)₃+4H₂O

2AlO(OH)+3H₂SO₄=Al₂(SO₄)₃+4H₂O

Iron/aluminum removal (with product);

H₂SO₄+2NaOH=Na₂SO₄+2H₂O

Al₂(SO₄)₃+6NaOH=2Al(OH)₃+3Na₂SO₄ (Aluminum hydroxide)

Fe₂(SO₄)₃+6NaOH=2Fe(OH)₃+3Na₂SO₄ (Iron hydroxide)

Al₂(SO₄)₃+6NaOH=2AlO(OH)+3Na₂SO₄+2H₂O (Aluminum oxyhydroxide)

Fe₂(SO₄)₃+6NaOH=2FeO(OH)+3Na₂SO₄+2H₂O (Iron oxyhydroxide)

Fe₂(SO₄)₃+6NaOH=Fe₂O₃+3Na₂SO₄+3H₂O (hematite)

3Al₂(SO₄)₃+12NaOH=2NaAl₃(SO₄)₂(OH)₆+5Na₂SO₄ (Alunite)

3Fe₂(SO₄)₃+12NaOH=2NaFe₃(SO₄)₂(OH)₆+5Na₂SO₄ (Jarosite)

### Nickel and Cobalt Precipitation

NiSO₄+2NaOH=Ni(OH)₂+Na₂SO₄

CoSO₄+2NaOH=Co(OH)₂+Na₂SO₄

### Iron/Aluminum/Manganese Removal Stage 2

Al₂(SO₄)₃+6NaOH=2Al(OH)₃+3Na₂SO₄ (Aluminum hydroxide)

Fe₂(SO₄)₃+6NaOH=2Fe(OH)₃+3Na₂SO₄ (Iron hydroxide)

Al₂(SO₄)₃+6NaOH=2AlO(OH)+3Na₂SO₄+2H₂O (Aluminum oxyhydroxide)

Fe₂(SO₄)₃+6NaOH=2FeO(OH)+3Na₂SO₄+2H₂O (Iron oxyhydroxide)

3Al₂(SO₄)₃+12NaOH=2NaAl₃(SO₄)₂(OH)₆+5Na₂SO₄ (Alunite)

3Fe₂(SO₄)₃+12NaOH=2NaFe₃(SO₄)₂(OH)₆+5Na₂SO₄ (Jarosite)

MnSO₄+Na₂S₂O₈+4NaOH=MnO₂+3Na₂SO₄+2H₂O

### Magnesium Hydroxide Precipitation

MgSO₄+2NaOH=Mg(OH)₂+Na₂SO₄

### Salt Splitting (Anion Exchange Membrane)

2Na₂SO₄+4H₂O=4NaOH+2H₂SO₄+2H₂+O₂

In alternative embodiments, processes make use of NaOH, NaHCO₂ or Na₂CO₃ precipitants, with some alternative chemistries shown below:

### Neutralization

Alkali hydroxide: H₂SO₄+2NaOH=Na₂SO₄+2H₂O

Alkali metal carbonate: H₂SO₄+Na₂CO₃=Na₂SO₄+H₂O+CO_{2(g)}

### Iron Precipitation

Alkali hydroxide: Fe₂(SO₄)₃+6NaOH=2Fe(OH)₃+3Na₂SO₄ or Fe₂(SO₄)₃+6NaOH=Fe₂O₃+3Na₂SO₄+3H₂O

Alkali metal carbonate: Fe₂(SO₄)₃+3Na₂CO₃+H₂O=2FeO(OH)+3Na₂SO₄+3CO_{2(g)}

### Nickel Recovery

Alkali hydroxide: NiSO₄+2NaOH=Ni(OH)₂+Na₂SO₄

Alkali metal carbonate: NiSO₄+Na₂CO₃=NiCO₃+Na₂SO₄

### Magnesium Recovery

Alkali hydroxide: MgSO₄+2NaOH=Mg(OH)₂+Na₂SO₄

Alkali metal carbonate (with Na₂CO₃): MgSO₄+Na₂CO₃=MgCO₃+Na₂SO₄

Alkali metal carbonate with NaOH/CO_{2(g)}: MgSO₄+2NaOH+CO₂=MgCO₃+Na₂SO₄+H₂O

The present processes may be integrated with other carbon sequestration processes, such as ocean alkalinity enhancement. This present processes for the production of synthetic brucite and calcium hydroxide accordingly address environmental risks of direct ocean alkalinity enhancement with untreated mafic rocks. The present processes also create a less carbon intensive source of magnesium and calcium hydroxides to be used as feedstock in carbon capture and storage, including direct air capture technologies. The use of the brucite or calcium hydroxide products of the present processes in a direct air capture (DAC) process may be carried out so as to eliminate calcining and slacking steps that are otherwise required in these processes. The present processes provide for the use of basaltic sands in less carbon intensive industrial purposes, by producing low carbon sources of nickel and iron hydroxides as well as amorphous silicate (SiO₂).

### Example

This Example relates to a process for the production of carbon negative nickel and cobalt battery material intermediates using a chloride based hydrometallurgical process route applied to saprolite ores. Amorphous silica, a supplementary cementitious material that can reduce the clinker content of cement mixes by 30%, is a coproduct. Magnesium hydroxide, a specialty chemical with several environmental applications, is the other major coproduct. The process uses HCl leaching of saprolite to produce the silica residue, and the leachate is neutralized to produce an iron/aluminum/chromium residue as a co-product. The iron-free solution is further neutralized to produce a mixed hydroxide precipitate (MHP) of nickel and cobalt followed by a high purity magnesium hydroxide precipitate. The final solution is a concentrated sodium chloride solution which is directed to chlor-alkali processing to produce HCl and NaOH for acid leaching and neutralization.

The general process flowsheet is shown in FIG. 14. The process involves a series of steps as set out below.

### Crushing and Grinding

Crushing and grinding in recycle brine solution containing a variety of chloride salts including magnesium chloride and sodium chloride. The purpose of recycle of a brine solution is to avoid the addition of water which can only be managed by evaporation which is expensive in terms of energy.

The three types of raw materials used in this Example were obtained from various sources. Table 1 shows the elemental composition of the raw materials tested. The nickel and cobalt content of the material increases from asbestos tailing to olivine to nickel saprolite sample. Iron levels are variable from ˜5% for the olivine sample up to 18% for the saprolite. The magnesium content was highest for olivine at 29.79% and only 12.2% for nickel saprolite. The silicon content varied over a narrow range of 15.6 to 19.49% Si. The samples were either used as received or ground to finer size as required.

TABLE 1
Composition of Raw Materials for Extraction

| Analysis | Asbestos | Olivine | Nickel Saprolite |
|---|---|---|---|
| (%) | Tailing | Sample | Sample |
| Ni | 0.239 | 0.34 | 1.81 |
| Co | 0.011 | 0.011 | 0.052 |
| Cu | 0.0019 | 0.002 | 0.005 |
| Zn | 0.0019 | 0.004 | 0.02 |
| Fe | 7.51 | 5.13 | 18.0 |
| Mg | 22.2 | 29.79 | 12.2 |
| Al | 0.5 | 0.19 | 2.19 |
| Cr | 0.25 | 0.28 | 0.78 |
| Mn | 0.07 | 0.08 | 0.65 |
| Ca | 0.26 | 0.08 | 0.33 |
| Si | 16.5 | 19.49 | 15.6 |
| Na | 0.06 | 0.04 | 0.02 |
| S | NA | NA | 0.02 |

### HCl Leaching

This process uses HCl at high strength (typically 30-36% HCl by weight in water; a typical product from an HCl production facility attached to a chlor alkali plant). The raw materials contain a variety of silicate minerals including magnesium, iron, nickel, cobalt, and minor impurity elements.

The chemistry therefore comprises the following major reactions:

Mg₂SiO₄+4HCl=2MgCl₂+SiO₂+2H₂O

Ni₂SiO₄+4HCl=2NiCl₂+SiO₂+2H₂O

Fe₂SiO₄+4HCl=2FeCl₂+SiO₂+2H₂O

Other minerals present such as iron oxides or aluminum oxides may also react with HCl to form additional salts in solution:

FeO(OH)+3HCl=FeCl₃+2H₂O

AlO(OH)+3HCl=AlCl₃+2H₂O

Natural minerals are not pure compounds. The minerals may contain a variety of elements (eg. Mg, Ni, Co, Fe in one silicate mineral) and may be hydrated or weathered. Suitable feed materials include: nickel saprolite ores, olivine ores, asbestos ores and tailings.

The conditions for leaching are typically a temperature between 85-95° C. to the boiling point (in select embodiments 115° C. or higher). Acid addition ranges from 500 to 1000 kg HCl per dry tonne of solid feed and will vary with the chemical composition of the feed. The brine recycle solution in the flowsheet below ensures that acid leaching is performed with a high total salt content as, for example, NaCl or MgCl₂ or both.

In select embodiments, the leaching time can vary from 1 hour to 8 hours. The leaching can be done in a single stage or two stage countercurrent. Single stage means that the acid and ore are added together and allowed to react at temperature to completion, while two stage means that fresh ore is contacted with partly reacted solution so as to maximize the consumption of acid (low terminal acidity) and in the second stage, the partly leached ore (from the first stage) is contacted with high acid to maximize extraction of Mg/Ni/Co/Fe, etc. The two stage process requires an additional solid/liquid separation step to ensure countercurrent movement of solids and liquids.

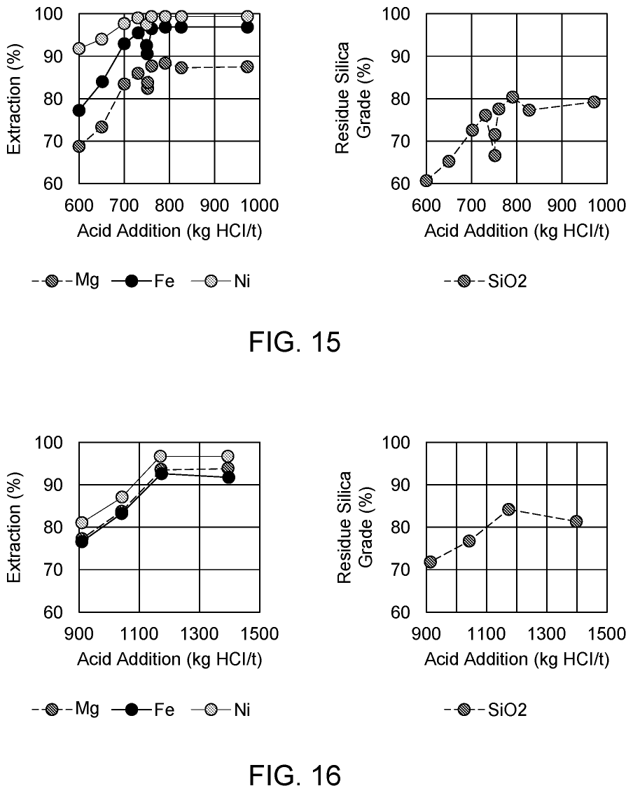

A series of HCl leaching tests were performed to illustrate the extraction of the key elements (Ni/Co/Mg/Fe/Al) and the quality of silica residue produced as a product. The leach extractions were highly sensitive to the acid addition, reported as kg HCl/tonne of material. The basis is kg HCl on a 100% basis and per tonne of dry ore (FIG. 15). The nickel extraction for the saprolite sample (FIG. 15) approached 100% at ˜750 kg HCl/t of ore. Iron and magnesium extractions were slightly lower. It was technically feasible to produce ≥75% SiO₂ content in the residue at the 750 kg HCl/t addition rate.

The olivine extraction results (FIG. 16) showed very similar extractions of Ni/Mg/Fe, consistent with the uniform mineralogy of the olivine sample. The acid required to reach maximum extraction was nearly 1200 kg HCl/t ore due to the more basic character of the olivine. The SiO₂ grade of the leach residue exceeded 80%.

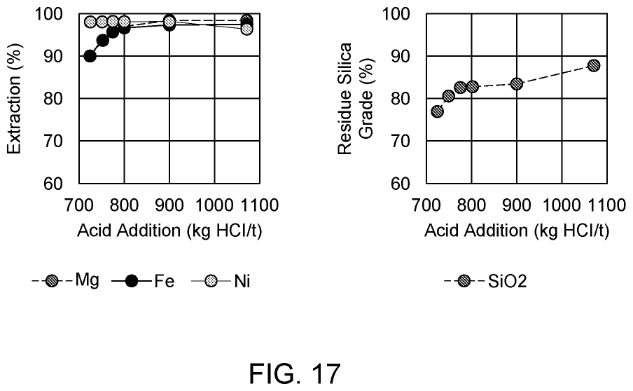

The results of the leaching of asbestos tailings (FIG. 17) showed very high Ni/Mg/Fe extractions at +800 kg HCl/t. The SiO₂ grade again exceeded 80% in concert with high base metal extractions.

The batch leaching results showed that a variety of raw materials could be treated with suitable levels of HCl to maximal extraction of the key metals and production of a silica rich residue.

The products of HCl leaching are a weakly acidic solution containing various chloride salts and a silica rich residue recovered as a solid product. This residue is washed to remove salts and excess acid with fresh water and then directed to cement manufacture where the silica is used as a replacement for other materials (thus lowering the carbon intensity of cement manufacture) and a strengthener to improve the yield strength of concrete (high performance concrete). An extensive study of the cementitious properties of the leach residues was conducted, with results indicating that the leach residues containing high levels of residual silica were well suited to addition to cement

### Iron and Aluminum Removal

The iron and aluminum content in the solution is precipitated as a mix of oxide and hydroxide solids by raising the pH with NaOH solution.

The NaOH solution is added as a 50% solution and may be diluted with recycle brine solution for process convenience and enhanced pH control (it may be difficult to control pH by adding such a strong base). The NaOH neutralizes the excess acid and precipitates Fe/Al and other trivalent cations if present, according to the following reactions:

HCl+NaOH=NaCl+H₂O

FeCl₃+3NaOH=FeO(OH)+3NaCl+H₂O

2FeCl₃+6NaOH=Fe₂O₃+6NaCl+3H₂O

AlCl₃+3NaOH=AlO(OH)+3NaCl+H₂O

2AlCl₃+6NaOH=Al₂O₃+6NaCl+3H₂O

CrCl₃+3NaOH=CrO(OH)+3NaCl+H₂O

2CrCl₃+6NaOH=Cr₂O₃+6NaCl+3H₂O

The pH adjustment is conducted with stoichiometric amounts of NaOH. Over addition will result in undesirable precipitation of Ni/Co so careful control of addition must be maintained. The temperature will be between 75° C. to the boiling point. Seed (precipitate) may be recycled to ensure growth of suitable sized particles for enhanced solid/liquid separation. Precipitation time can be 1 to 8 hours. NaOH is added progressively through the precipitation tanks (continuous) so as to enhance precipitation of coarser/separable precipitates. The product undergoes S/L separation and washing. The iron/aluminum residue may be treated to form commercial products.

The iron and aluminum removal process can be performed in a two stage arrangement to allow recycle of the second stage precipitate to the leaching section to minimize any nickel and cobalt loss and to maximize the removal of iron, aluminum, and chromium. Further, if the iron is partly in the ferrous state, a small amount of sodium hypochlorite may be added to oxidize residual ferrous to the ferric state.

In an alternative iteration of the process, the NaOH solution, with a pH of ˜14 for a 40 g/L NaOH solution, is directed to CO₂ adsorption, converting NaOH to Na₂CO₃ which is lower strength base, with a pH of around 12-12.5. The Na₂CO₃ solution was then used, as an alternative to an NaOH solution, as the precipitant (i.e. the alkali metal carbonate precipitant). In the exemplified pilot processes, when using the Na₂CO₃ solution to precipitate Fe, the Na₂CO₃ as a milder base provides for a more effective and controlled precipitation process for Fe. This is also the case with the use of the Na₂CO₃ solution to precipitate Al/Cr. In the pilot process, iron precipitation using Na₂CO₃ (soda ash) was performed with seeding with hematite seed, and the extent of iron precipitation was about 98%. The relevant reactions include:

2FeCl₃+3Na₂CO₃+H₂O=2FeO(OH)+6NaCl+3CO_{2(g)}.

### Nickel and Cobalt Recovery

Nickel and cobalt are present in solution as NiCl₂ and COCl₂ salts. The recovery of Ni/Co can be done in many ways including the direct precipitation of mixed hydroxide precipitate. This can be done directly from the solution coming from the iron precipitation. Alternately ion exchange loading and elution with a bis-picolyamine resin can be used to recover an ion exchange eluant containing nickel and cobalt chloride at higher concentration. In this Example, a solution of sodium hydroxide is added to form the precipitates.

NiCl₂+2NaOH=Ni(OH)₂+2NaCl

CoCl₂+2NaOH=Co(OH)₂+2NaCl

Other metals will also precipitate with the Ni/Co in minor amounts, such as Mn and Fe (remaining iron in solution). If an excess of sodium hydroxide is added, then magnesium will co-precipitate as magnesium hydroxide. The selectivity of MHP precipitation can be enhanced by using two stage MHP precipitation. The second stage precipitate is recovered and recycled to the first stage or to the discharge from the main leaching step (where acid is present to redissolve the Ni/Co and other metals from the second stage leach).

The mixed hydroxide precipitate is recovered by solid-liquid separation and washing. A pressure filter is often used with a “squeeze” cycle to minimize the entrained moisture in the washed MHP cake prior to shipping.

The precipitation is carried out between 25-90° C. and terminal pH is in the range of 5-8. Note that pH measurement is difficult in a strong salt solution, and sodium hydroxide addition can also be controlled by stoichiometry. The precipitation time is 1-8 hours. Seed recycling is used to maximize particle size and minimize contamination. The process (as in all steps) is conducted continuously.

In an alternative iteration of the pilot process, when Na₂CO₃ solution is used to precipitate Ni/Co, a Ni/Co mixed carbonate precipitate is produced, which surprisingly provided a mixed product that was more crystalline, easier to separate from solution, lower in chloride content, and lower in moisture when filtered—compared the results when using NaOH as precipitant. In particular, the use of the Na₂CO₃ solution as precipitate produced a 41.2% grade of Ni in the mixed carbonate product, an excellent grade of solids for NiCO₃, and complete removal of nickel with the soda ash precipitant. The relevant reactions including:

NiCl₂+Na₂CO₃=NiCO₃+2NaCl.

### Manganese Removal

Manganese is an undesirable impurity in magnesium hydroxide, and can not be selectively precipitated as a hydroxide in the presence of magnesium hydroxide. Accordingly, oxidation and precipitation is used to remove manganese from solution.

MnCl₂+NaOCl+2NaOH=MnO₂+H₂O+3NaCl

The manganese dioxide precipitate is filtered and washed.

### Magnesium Hydroxide Precipitation.

The remaining magnesium in solution is precipitated by addition of NaOH to form Mg(OH)₂.

MgCl₂+2NaOH=Mg(OH)₂+2NaCl

This can be done by adding NaOH to MgCl₂ solution or by reversing the order of addition. The goal is to provide a near complete removal of Mg as Mg(OH)₂ from solution, requiring a near stoichiometric addition of NaOH.

### Chlor-Alkali Plant

The final solution is NaCl and H₂O with some minor contaminants in solution. This solution is directed to a chlor-alkali plant for manufacture of NaOH, Cl₂, and H₂. This involves many steps. The Cl₂ and H₂ can be burned and water-scrubbed to form strong HCl solution for recycle to leaching.

The excess heat from combustion is recovered as steam and used to evaporate excess water from solution.

### Batch Testing of the Downstream Process Operations

An extensive series of batch leach tests were carried out. In addition, the foregoing process operations were also tested step by step in a series of further exemplified embodiments. Table 2 below shows the changing composition of solutions within the sequential unit operations in the flowsheet as applied to a nickel saprolite sample.

TABLE 2
Solution Compositions (mg/L) Through Downstream
Unit Operations (Leach = HCl Leach, IR =
Iron Removal, MHP = Mixed Hydroxide Precipitation,
MnR = Manganese Removal, MP = Magnesium
Hydroxide Precipitation).

| Operation | Leach | IR | MHP | MnR | MP |
|---|---|---|---|---|---|
| Mg | 69600 | 63000 | 68800 | 62300 | 3.1 |
| Ni | 3370 | 2210 | 300 | 1.7 | 0.6 |
| Fe | 36900 | 3.6 | 0.3 | 0.2 | 0.5 |
| Al | 3470 | 10 | 0.2 | 0.2 | 0.2 |
| Mn | 750 | 640 | 630 | 0.05 | 0.05 |
| Na | 24 | 25500 | 27400 | 25200 | 125000 |
| Test ID | SL2 | IR5 | MHP1 | MnR3 | MP5 |

The leach solution contains over 3 g/L of Ni and high levels of Mg, Fe, and Al. The IR solution shows very low terminal Fe and Al concentrations and somewhat reduced Ni concentration, a consequence of some dilution due to base addition and some co-precipitation of Ni. The sodium level is increased due to NaOH addition, while manganese is diluted to 640 mg/L Mn in solution. The MHP (primary) solution shows very low Fe/Al and significant reduction in Ni. This experiment produced a high grade MHP product (+40% Ni on a dry basis). The MnR solution shows an excellent rejection of Mn from solution (to 0.05 mg/L of Mn) by oxidation and pH adjustment. Further, the MP precipitation results show very low residual content of Mg, Ni, Fe, Al, and Mn. The final concentration of Na was 125 g/L Na, corresponding to 318 g/L NaCl. This brine would undergo further treatment in a conventional chlor-alkali circuit to polish minor contamination before electrolysis.

### Continuous Pilot Plant Results

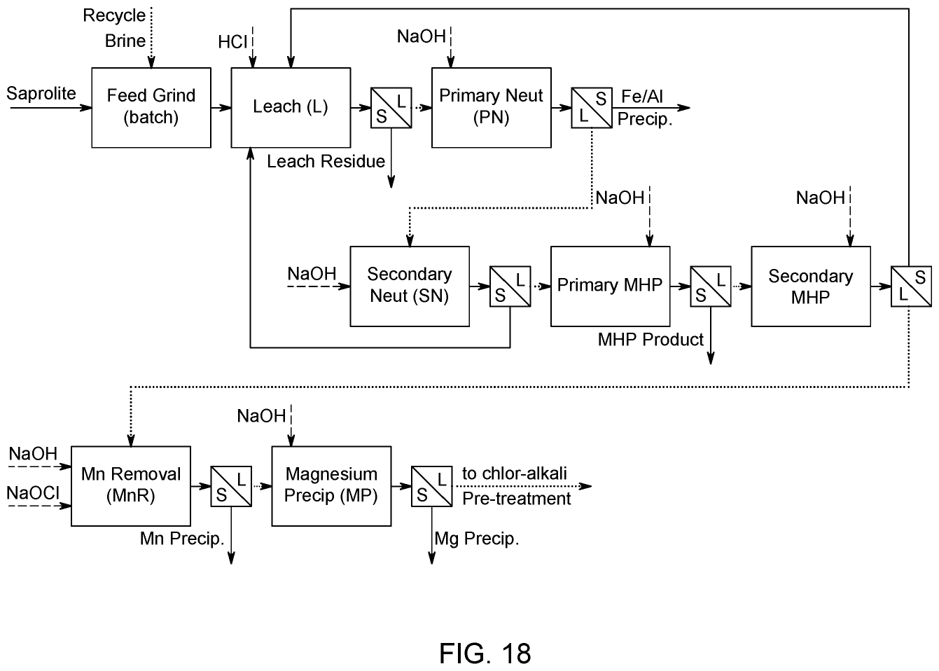

A continuous pilot plant was established to illustrate the integration of key elements of the process, from ground ore feed to the production of silica residue, iron/aluminum precipitate, mixed hydroxide of nickel and cobalt, manganese precipitate, and finally magnesium hydroxide precipitate (FIG. 18). The barren solution after magnesium removal is also a product but in this case for recycle through a chlor-alkali facility for manufacture of sodium hydroxide and hydrochloric acid supply.

The pilot plant was run on a prepared sample of ground saprolite (Table 1) with grinding performed in recycle brine solution (FIG. 14). Leaching was performed with ˜750-800 kg HCl/t feed material and 95° C. for 10 days total (two periods of 5 days). The leach slurry was collected and filtered in a pressure filter to recover the silica residue and the leach solution was directed to primary neutralization. A hematite-rich seed slurry was added to the feed solution as it entered four stages of neutralization with NaOH solution. The slurry product was thickened and the thickener UF was divided into seed recycle and final product. The primary neutralization thickener overflow was sent through secondary neutralization (four stages followed by thickening), where additional NaOH solution was added. The secondary neutralization thickener UF was recycled to leaching and the OF was directed to MHP production. MHP production was performed in two stages (primary and secondary), and the second stage MHP thickener UF was recycled to leaching. The MHP thickener OF was sent to manganese removal. This was performed by oxidation with NaOCl and pH adjustment (with caustic addition) to form a manganese oxide product. Finally, the manganese free filtrate advanced to magnesium hydroxide precipitation with sodium hydroxide addition.

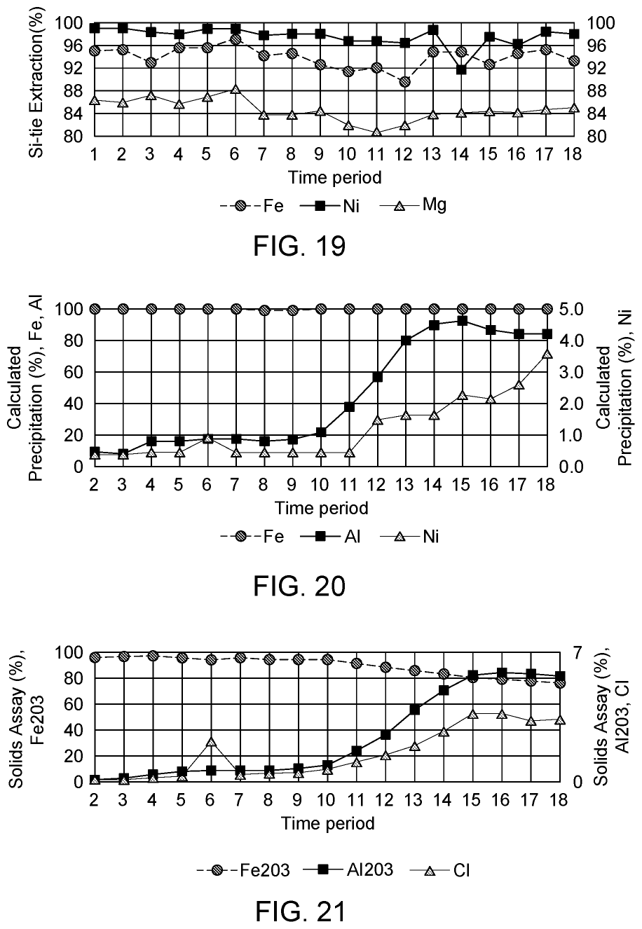

The pilot plant operation was divided into 18 periods (each period was ˜12 hours) over which data was collected and mass balances calculated. FIG. 19 shows metal extraction version time over these periods. The extraction of Ni in the saprolite leaching process was generally in the range of 96-99%. The Fe extraction was slightly lower and the Mg lower again. The acid addition rate was varied during the run and the changing extraction results are reflected by an increase or decrease in acid addition. The reported extractions are calculated by the Si-tie method where Si is assumed to be insoluble.

Primary neutralization results are shown in FIG. 20 and FIG. 21. The iron removal results are consistent at nearly 100% efficiency. The aluminum removal results showed an increase toward the end of the pilot plant with a commensurate rise in nickel coprecipitation. This illustrates the advantages associated with exercising process control so as to avoid a nickel loss while still removing sufficient aluminum in this step. Aluminum precipitation is an indicator of potential nickel loss. Accordingly, an aspect of the present invention involves metering NaOH addition so as to avoid over-add NaOH at this stage, mitigating nickel losses. The solid assay from the primary neutralization circuit showed a plateau of approximately 80% Fe₂O₃ with 5.5% Al₂O₃ and 4% Cl. The iron and aluminum precipitates are hydrated and the chloride in the residue is likely due to formation of hydroxy chloride precipitates of iron and aluminum.

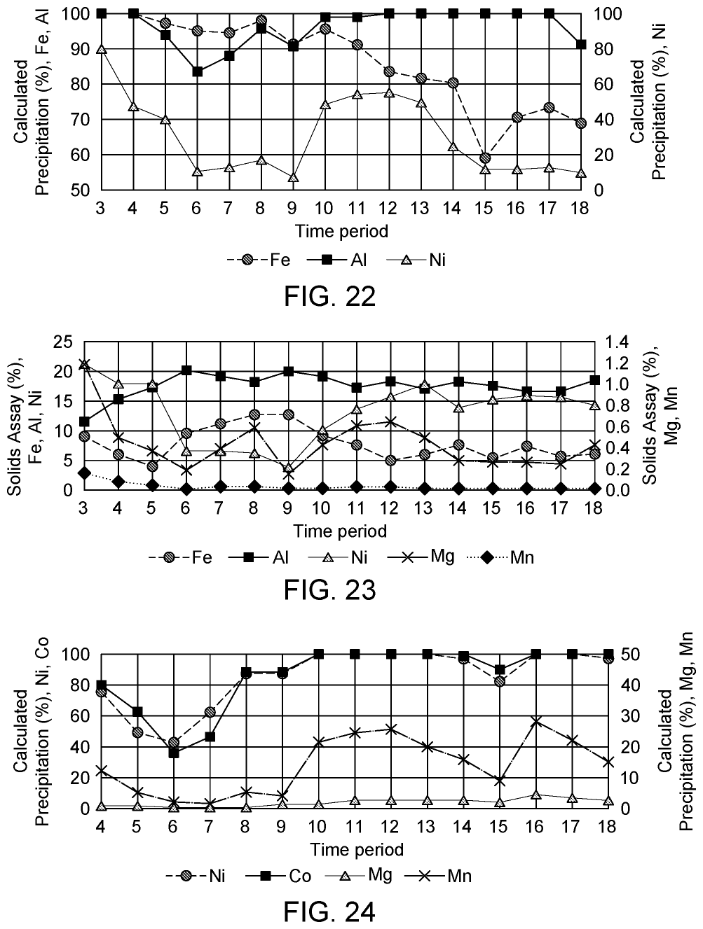

The secondary neutralization results (FIG. 22 and FIG. 23) show excellent removal of iron and aluminum. However, if aluminum removal is too efficient, the precipitation of nickel increases. This is not a problem in the sense that the secondary neutralization residue is recycled and nickel is re-leached. However, the nickel needs to move downstream to MHP precipitation, and therefore in advantageous adaptations of the present process nickel co-precipitation and aluminum removal are kept in balance so as to avoid excessive nickel buildup in the Leach-Secondary Neutralization part of the circuit.

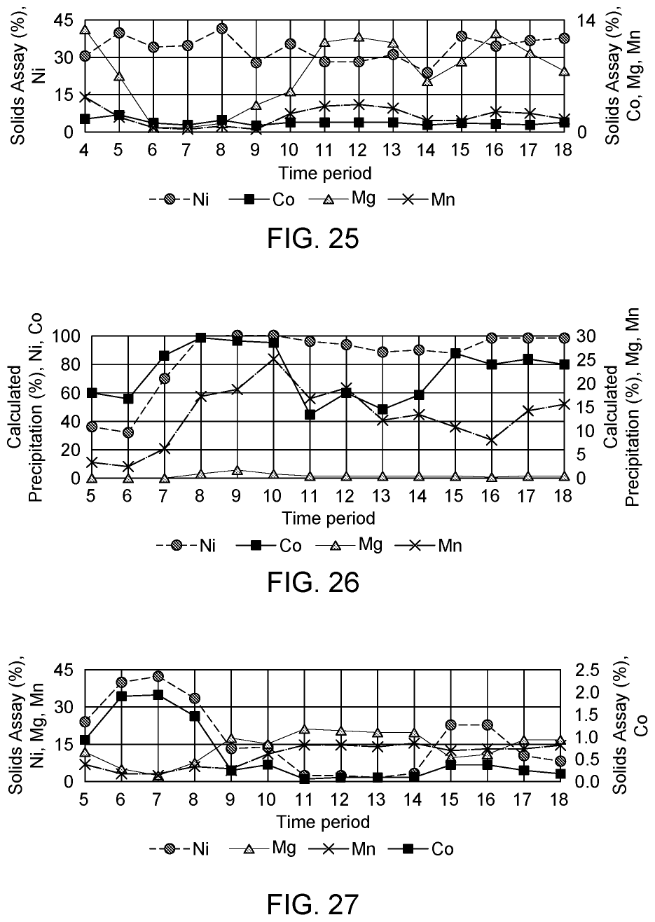

The primary mixed hydroxide precipitation results (FIG. 24 and FIG. 25) showed that nickel could be precipitated to form high grade MHP at as high as ˜40% Ni on a dry basis (periods 5-8). The results also show the advantages associated with effective control of NaOH addition. During periods 9-18, excess NaOH was added, leading to increased precipitation of Mg and some Mn. The stability of this circuit is impacted by the upstream process steps and especially by the recycling of nickel and cobalt back to leach. Further, the measurement of pH in the strong brine solution as a measure of control impacts the control of the MHP circuit.

The secondary mixed hydroxide precipitation results (FIG. 26 and FIG. 27) show the effective capture of residual nickel arriving from the primary mixed hydroxide circuit. Again the correct dosage and control of NaOH addition is illustrated to be an important aspect of select embodiments of the present processes. As illustrated, under-addition of NaOH may result in loss of soluble Ni and Co to the manganese removal circuit while over-addition may cause the precipitation of Mg and Mn.

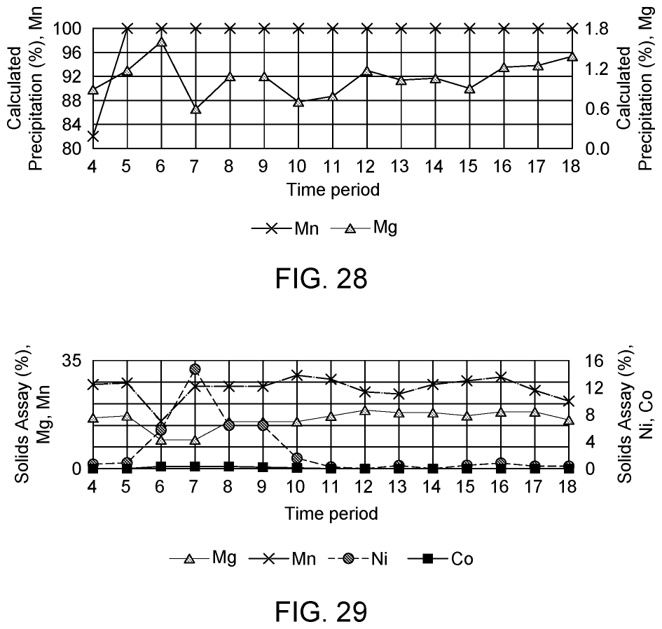

The manganese removal circuit (FIG. 28 and FIG. 29) was stable and yielded very high levels of manganese removal by effective oxidation and pH adjustment. Small levels of magnesium precipitation occurred through the operation, unavoidable due to the elevated pH used for manganese removal. The operation between period 5 and 10 showed some nickel in the manganese precipitate, due to incomplete nickel removal in the secondary mixed hydroxide precipitation circuit. Beyond this point (periods 11 and beyond), the nickel in solution in the feed to manganese precipitation was very low and hence the content of the manganese precipitate was very low.

The magnesium precipitation results were excellent (Table 3). The magnesium precipitation circuit operated toward the end of the 10 day pilot plant run. The key impurity elements were generally very low with the exception of chloride, which likely formed magnesium hydroxy chloride precipitates under startup conditions. Any of the other di- or tri-valent metals present in the feed to magnesium precipitation will co-precipitate with the magnesium. Magnesium precipitation efficiency was ˜100%. The brine formed as a product from this process step is ideal as a feed to brine softening ahead of the chlor-alkali plant operation.

TABLE 3
Magnesium precipitate analysis.
Chemical Analysis (%)

| Period | Fe | Al | Cl | Ni | Co | Mn | MgO |
|---|---|---|---|---|---|---|---|
| 16 | <0.01 | 0.02 | 4.4 | <0.01 | <0.01 | <0.01 | 61.3 |
| 17 | 0.01 | 0.04 | 0.2 | 0.11 | <0.01 | 0.01 | 63.1 |

As illustrated in this example, surprising metrics were achieved in the pilot plant operation of the present process.
The leach extractions of nickel and cobalt were in the range of 96-99% in the primary HCl leach.
The primary neutralization circuit removed iron and aluminum effectively with minimal co-precipitation of nickel and cobalt.
The secondary neutralization circuit was effective at polishing residual iron and aluminum content from the solution prior to mixed hydroxide precipitation.
The primary mixed hydroxide precipitation produced product grading up to 40% Ni on a dry basis. Under controlled conditions, co-precipitation of magnesium and manganese could be avoided. The testing highlighted the need to develop improved measurement of pH in the strong brine solutions used in this process so as to enhance control and selectivity of the key process steps.
The secondary mixed hydroxide precipitation was effective at precipitating residual value metals.
The manganese removal circuit utilizing oxidation and pH adjustment for precipitation was outstanding in performance with virtually 100% removal of manganese from solution.
The magnesium precipitation process product was high grade and low in metallic impurities. The magnesium precipitation process is dependent on all of the upstream processes to produce a suitable precipitate product. The brine from the magnesium precipitation process was virtually free of any impurities and suitable as a source of NaCl brine to proceed to brine softening and chlor-alkali processing to regenerate HCl and NaOH for the process.

The silica leach residue from batch leaching of saprolite, olivine and asbestos tailing was evaluated as an additive to cement. The results confirmed that the leach residues were reactive and suitable for cement making. The testing of the cementitious properties of the residue will be reported in a further publication.

The overall recovery of nickel and cobalt from the process is expected to be in the range of +95%. The MHP product is suitable for further post processing to produce battery material precursor materials to support the rapidly increasing demand in the electric vehicle space. The magnesium hydroxide product from the process is an ideal material to support decarbonisation.

### CONTEXT

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. The invention includes all embodiments and variations substantially as hereinbefore described and with reference to the examples and drawings.

Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein, including references set out below:
Bach et al., 2019, CO₂ Removal With Enhanced Weathering and Ocean Alkalinity Enhancement: Potential Risks and Co-benefits for Marine Pelagic Ecosystems, Frontiers in Climate, vol. 1, pg 7.
Ruhaimi, A. H., Aziz, M. A. A., Jalil, A. A., 2021, Magnesium oxide-based adsorbents for carbon dioxide capture: Current progress and future opportunities, Journal of CO₂ Utilization, Volume 43, p.101357.

1. A process for processing a comminuted mineral feedstock, comprising:
a) leaching metal values from the comminuted mineral feedstock with an acid leachant, to produce a solid siliceous residue and a loaded leach solution;
b) precipitating iron and/or aluminum from the loaded leach solution with addition of:
an first alkaline-earth metal oxide precipitant,
a first alkali metal carbonate precipitant, to produce a carbon dioxide off gas, or,
a first alkali hydroxide precipitant,
to produce an Fe/Al depleted solution and an iron and/or aluminum hydroxide or oxide precipitate product;
c) precipitating nickel and/or cobalt from the Fe/Al depleted solution or from a Ni/Co ion exchange eluant obtained from the Fe/Al depleted solution by selective extraction of nickel and/or cobalt on an ion exchange medium, wherein the precipitating is with addition of:
a second alkaline-earth metal oxide precipitant,
a second alkali metal carbonate or bicarbonate precipitant, or,
a second alkali hydroxide precipitant,
to produce a Ni/Co depleted solution and a nickel and/or cobalt carbonate or hydroxide precipitate product;
d) before or after step (c), precipitating iron and/or aluminum and/or manganese from the Ni/Co depleted solution with addition of an oxidant and with addition of:
a third alkali metal carbonate or bicarbonate precipitant, or,
a third alkali hydroxide precipitant,
to produce an Fe/Al/Mn depleted solution and an iron and/or aluminum and/or manganese hydroxide precipitate product;
e) optionally precipitating magnesium from the Fe/Al/Mn depleted solution with addition of:
a fourth alkali hydroxide precipitant, or
a fourth alkali metal carbonate or bicarbonate precipitant,
to produce a Mg-depleted solution and a magnesium hydroxide or carbonate precipitate product;
e′) in place of precipitating magnesium from the Fe/Al/Mn depleted solution, precipitating manganese from the Fe/Al/Mn depleted solution, with the addition of a third alkaline-earth metal oxide precipitant, to produce a solid manganese residue and a magnesium chloride solution;
f) optionally subjecting the Mg-depleted solution to an electrolysis process to produce the acid leachant and:
one or more of the alkali hydroxide precipitants, or
an alkali hydroxide product;
f′) in place of subjecting the Mg-depleted solution to the electrolysis process, applying heat to the magnesium chloride solution to produce a magnesium chloride solid product, then applying heat to the magnesium chloride solid product to pyrolytically produce the acid leachant and a magnesium oxide product.

2. The process of claim 1, further comprising reacting the alkali hydroxide product of the electrolysis process directly or indirectly with a carbon source to produce one or more of the alkali-earth metal carbonate, alkali metal carbonate or bicarbonate precipitants.

3. The process of claim 2, wherein reacting the alkali hydroxide product with a carbon source comprises scrubbing carbon dioxide from a CO₂ containing gas by treating the CO₂ containing gas with a scrubbing solution comprising the alkali hydroxide product, to produce one or more of the alkali-earth metal carbonate, alkali metal carbonate or bicarbonate precipitants.

4. The process of claim 3, wherein the alkali hydroxide product comprises NaOH, wherein scrubbing carbon dioxide from the CO₂ containing gas comprises precipitating Na₂CO₃ hydrates from the scrubbing solution in a crystallisation process to produce a solid Na₂CO₃ crystallizer product.

5. The process of claim 4, wherein scrubbing carbon dioxide from the CO2 containing gas produces a Na2CO3 loaded solution, and the Na2CO3 loaded solution is directed for use as one or more of the alkali metal carbonate precipitants.

6. The process of claim 5, wherein the Na2CO3 loaded solution provides the first alkali metal carbonate precipitant for precipitating iron and/or aluminum from the loaded leach solution.

7. The process of claim 5 or 6, wherein the Na2CO3 loaded solution provides the second alkali metal carbonate precipitant for precipitating nickel and/or cobalt from the Fe/Al depleted solution.

8. The process of any one of claims 4-7, wherein the solid Na₂CO₃ crystallizer product comprises sodium carbonate decahydrate (Na₂CO₃·10H₂O).

9. The process of any one of claims 4-8, wherein scrubbing carbon dioxide from the CO₂ containing gas comprises an evaporative carbon capture circuit and precipitating Na₂CO₃ hydrates from the scrubbing solution comprises a cooling crystallization circuit, wherein metered quantities of heat and water are added to the evaporative carbon capture circuit.

10. The process of claim 9, wherein evaporative carbon capture circuit is carried out at a carbon capture temperature range of 10-20° C., and the cooling crystallization circuit is carried out at a crystallization temperature of 0-10° C., and wherein water is added to the carbon capture circuit so as to make up for evaporative losses.

11. The process of any one of claims 1-10, further comprising precipitating calcium from the Mg-depleted solution with a fifth alkali hydroxide precipitant, to produce a calcium hydroxide product, and generating one or more of the alkali-earth metal carbonate, alkali metal carbonate or bicarbonate precipitants by treating the calcium hydroxide product with a carbon source.

12. The process of claim 11, wherein the carbon source is a CO₂ containing gas or a metal carbonate.

13. The process of claim 3, 4 or 12, wherein the CO₂ containing gas comprises air.

14. The process of claim 4, wherein one or more of the alkali metal carbonate or bicarbonate precipitants comprises the solid Na₂CO₃ crystallizer product.

15. The process of any of claims 1-14, wherein the alkali metal carbonate or bicarbonate precipitant comprises NaHCO₃, Na₂CO₃ or K₂CO₃.

16. The process of any one of claims 1-15, wherein the alkali hydroxide precipitant comprises NaOH or KOH.

17. The process of any one of claims 1-16, wherein the acid leachant comprises a mineral acid, HCl or H₂SO₄.

18. The process of any one of claims 1-17, wherein the electrolysis process comprises a chloralkali process producing the alkali hydroxide precipitant and/or the alkali hydroxide product, a Cl_{2(g)} product and a H_{2(g)} product, further comprising reacting the Cl_{2(g)} product and the H_{2(g)} product to produce HCl as the acid leachant.

19. The process of any one of claims 1-17, wherein the Mg-depleted solution comprises Na₂SO₄, wherein the electrolysis process comprises a salt splitting process comprising electrolytic generation of: the alkali hydroxide product and/or the alkali hydroxide precipitant; and, H₂SO₄ as the acid leachant.

20. The process of any one of claims 1-19, wherein precipitating magnesium from the Fe/Al/Mn depleted solution with the alkali hydroxide precipitant, further comprises addition of a CO_{2(g)} precipitant to produce the Mg-depleted solution and the magnesium carbonate precipitate product.

21. The process of claim 20, wherein the CO_{2(g)} precipitant comprises the carbon dioxide off gas from the step of precipitating iron and/or aluminum from the loaded leach solution.

22. The process of any one of claims 1-21, wherein the oxidant comprises chlorine gas (Cl_{2(g)}) or sodium hypochlorite (NaOCl).

23. The process of any one of claims 1-22, wherein the nickel and/or cobalt hydroxide precipitate is a mixed Ni/Co hydroxide product.

24. The process of any one of claims 1-23, further comprising magnetically separating material from the comminuted mineral feedstock.

25. The process of any one of claims 1-24, further comprising subjecting the loaded leach solution to a resin in leach process so as to selectively remove nickel values from the loaded leach solution, to obtain a purified nickel product.

26. The process of any one of claims 1-25, further comprising washing and/or alkalization of the solid siliceous residue.

27. The process of any one of claims 1-26, further comprising washing and/or alkalization of the iron and/or aluminum hydroxide or oxide precipitate product.

28. The process of any one of claims 1-27, further comprising adding a hematite seed material to the step of precipitating iron and/or aluminum so as to seed the precipitation of a hematite product.

29. The process of any one of claims 1-27, wherein the iron and/or aluminum hydroxide or oxide precipitate product comprises a hematite seed material, and the hematite seed material is recirculated to the step of precipitating iron and/or aluminum so as to seed the precipitation of a hematite product.

30. The process of any one of claims 1-29, further comprising recycling a brine comprising the Fe/Al/Mn depleted solution to a comminuting step to provide the comminuted mineral feedstock.

31. The process of any one of claims 1-30, wherein the mineral feedstock comprises a nickel saprolite ore or tailing, an olivine ore or tailing, an asbestos ore or tailing, a mafic mineral, a saprolite material, an ultramafic rock, olivine or wollastonite.

32. The process of claim 1, wherein the alkaline-earth metal oxide precipitant comprises a slurry of MgO.

33. The process of claim 1, further comprising reacting the magnesium oxide product, directly or indirectly, with a carbon dioxide containing gas to sequester carbon dioxide.

34. A process for processing a comminuted mineral feedstock, comprising:
optionally magnetically separating material from the comminuted mineral feedstock;
a) leaching metal values from the comminuted mineral feedstock with an acid leachant, to produce a solid siliceous residue and a loaded leach solution;
optionally subjecting the loaded leach solution to a resin in leach process so as to selectively remove nickel values from the loaded leach solution, to obtain a purified nickel product,
optionally, washing and/or alkalization of the solid siliceous residue;
b) precipitating iron and/or aluminum from the loaded leach solution with addition of:
a first alkali metal carbonate or bicarbonate precipitant, to produce a carbon dioxide off gas, or,
a first alkali hydroxide precipitant,
to produce an Fe/Al depleted solution and an iron and/or aluminum hydroxide or oxide precipitate product, optionally a hematite product;
optionally, washing and/or alkalization of the iron and/or aluminum hydroxide precipitate product;
optionally, adding a hematite seed material to the step of precipitating iron and/or aluminum, and further optionally wherein the iron and/or aluminum hydroxide or oxide precipitate product comprises the hematite seed material;
c) precipitating nickel and/or cobalt from the Fe/Al depleted solution or from a Ni/Co ion exchange eluant obtained from the Fe/Al depleted solution by selective extraction of Ni and/or cobalt on an ion exchange medium, wherein the precipitating is with addition of:
a second alkali metal carbonate or bicarbonate precipitant, or,
a second alkali hydroxide precipitant,
to produce a Ni/Co depleted solution and a nickel and/or cobalt carbonate or hydroxide precipitate product;
d) before or after step (c), precipitating iron and/or aluminum and/or manganese from the Ni/Co depleted solution with addition of an oxidant and with addition of:
a third alkali metal carbonate or bicarbonate precipitant, or,
a third alkali hydroxide precipitant,
to produce an Fe/Al/Mn depleted solution and an iron and/or aluminum and/or manganese hydroxide precipitate product;
optionally recycling a brine comprising the Fe/Al/Mn depleted solution to a comminuting step to provide the comminuted mineral feedstock;
e) precipitating magnesium from the Fe/Al/Mn depleted solution with addition of:
a fourth alkali hydroxide precipitant, or
a fourth alkali metal carbonate or bicarbonate precipitant,
to produce a Mg-depleted solution and a magnesium hydroxide or carbonate precipitate product;
f) subjecting the Mg-depleted solution to an electrolysis process to produce the acid leachant and:
one or more of the alkali hydroxide precipitants, or
an alkali hydroxide product; and,
g) sequestering carbon dioxide from a CO₂ containing gas, by reacting the CO₂ containing gas directly or indirectly with the alkali hydroxide product, in one or more of: the nickel and/or cobalt carbonate precipitate product; or, the magnesium carbonate precipitate product.

35. A process for processing a comminuted mineral feedstock, comprising:
a) leaching metal values from the comminuted mineral feedstock with an HCl acid leachant, to produce a solid siliceous residue and a loaded leach solution;
a′) washing and/or alkalization of the solid siliceous residue, for example to form a supplementary cementitious material (SCM) for use in cements;
b) precipitating iron and aluminum from the loaded leach solution with addition of:
a first alkali hydroxide precipitant, NaOH,
to produce an Fe/Al depleted solution and an iron and aluminum hydroxide/oxide precipitate product;
b′) washing the iron and aluminum hydroxide/oxide precipitate product;
c) precipitating nickel and cobalt from the Fe/Al depleted solution, wherein the precipitating is with addition of:
a second alkali hydroxide precipitant, NaOH,
to produce a Ni/Co depleted solution and a nickel and cobalt mixed hydroxide precipitate product;
d) precipitating manganese from the Ni/Co depleted solution with addition of an NaOCl oxidant and with addition of:
a third alkali hydroxide NaOH precipitant,
to produce an Mn depleted solution and a manganese hydroxide precipitate product;
d′) recycling a brine comprising the Mn depleted solution to a comminuting step to provide the comminuted mineral feedstock;
e) precipitating magnesium from the Mn depleted solution with addition of:
a fourth alkali hydroxide NaOH precipitant, or
to produce a Mg-depleted solution and a magnesium hydroxide or precipitate product;
f) optionally subjecting the Mg-depleted solution to an electrolysis process to produce the acid leachant and:
the NaOH alkali hydroxide precipitants.
